(19) United States
(12) Patent Application Publication
(10) Pub. No.: US 2022/0138150 A1
(43) Pub. Date: May 5, 2022

(54) MANAGING CLUSTER TO CLUSTER REPLICATION FOR DISTRIBUTED FILE SYSTEMS

(71) Applicant: Qumulo, Inc., Seattle, WA (US)

(72) Inventors: Michael Anthony Chmiel, Seattle, WA (US); Christopher Charles Harward, Vancouver (CA); Kevin David Jamieson, North Vancouver (CA); Shawn Kang, Seattle, WA (US); Sihang Su, Vancouver (CA)

(21) Appl. No.: 17/115,529

(22) Filed: Dec. 8, 2020

Related U.S. Application Data
(60) Provisional application No. 63/108,247, filed on Oct. 30, 2020.

(51) Int. Cl. G06F 16/11; G06F 16/182; G06F 16/17; G06F 16/16

(52) U.S. Cl. CPC G06F 16/128; G06F 16/1844; G06F 16/162; G06F 16/1734; G06F 16/1827

(57) ABSTRACT

Embodiments are directed to managing data in a file system over a network. A source file system and a target file system associated based on a replication relationship associated with snapshot policies. Snapshots may be generated on the source file system based on snapshot policies such that each snapshot is an archive of the source file system. The snapshots may be added to a queue on the source file system that may be associated with the replication relationship such that the snapshot is associated with a snapshot retention period that is local to the source file system and a remote replication retention period based on the replication relationship. Copying the snapshot to the target file system based on the remote replication retention period being unexpired.

### CROSS-REFERENCE TO RELATED APPLICATION

This application is a Utility patent application based on previously filed U.S. Provisional Patent Application No. 63/108,247 filed on Oct. 30, 2020, the benefit of the filing date of which is hereby claimed under 35 U.S.C. § 119(e) and which is further incorporated in entirety by reference.

### TECHNICAL FIELD

The present invention relates generally to file systems, and more particularly, but not exclusively, to managing cluster to cluster replication in a distributed file system environment.

### BACKGROUND

Modern computing often requires the collection, processing, or storage of very large data sets or file systems. Accordingly, to accommodate the capacity requirements as well as other requirements, such as, high availability, redundancy, latency/access considerations, or the like, modern file systems may be very large or distributed across multiple hosts, networks, or data centers, and so on. File systems may require various backup or restore operations. Naïve backup strategies may cause significant storage or performance overhead. For example, in some cases, the size or distributed nature of a modern hyper-scale file systems may make it difficult to determine the objects that need to be replicated. Also, the large number of files in modern distributed file system may make managing state or protection information difficult because of the resources that may be required to visit the files to manage state or protection information for files. Also, in some cases, for various reasons point in time snapshots may be difficult to manage across clusters of large file systems. Thus, it is with respect to these considerations and others that the present invention has been made.

### BRIEF DESCRIPTION OF THE DRAWINGS

Non-limiting and non-exhaustive embodiments of the present innovations are described with reference to the following drawings. In the drawings, like reference numerals refer to like parts throughout the various figures unless otherwise specified. For a better understanding of the described innovations, reference will be made to the following Detailed Description of Various Embodiments, which is to be read in association with the accompanying drawings, wherein:

FIG. 1 illustrates a system environment in which various embodiments may be implemented;

FIG. 2 illustrates a schematic embodiment of a client computer;

FIG. 3 illustrates a schematic embodiment of a network computer;

FIG. 4 illustrates a logical architecture of a system for managing cluster to cluster replication for distributed file systems;

FIG. 5 illustrates a logical representation of a file system for managing cluster to cluster replication for distributed file systems in accordance with one or more of the various embodiments;

FIG. 6 illustrates a logical represent of two file systems arranged for managing cluster to cluster replication for distributed file systems in accordance with one or more of the various embodiments;

FIG. 7 illustrates of logical schematic of a portion of data structures for managing cluster to cluster replication for distributed file systems in accordance with one or more of the various embodiments;

FIG. 8 illustrates an overview flowchart for a process for managing cluster to cluster replication for distributed file systems in accordance with one or more of the various embodiments;

FIG. 9 illustrates a flowchart for a process for managing cluster to cluster replication for distributed file systems in accordance with one or more of the various embodiments;

FIG. 10 illustrates a flowchart for a process for managing cluster to cluster replication for distributed file systems in accordance with one or more of the various embodiments; and

FIG. 11 illustrates a flowchart for a process for managing cluster to cluster replication for distributed file systems in accordance with one or more of the various embodiments.

### DETAILED DESCRIPTION OF VARIOUS EMBODIMENTS

Various embodiments now will be described more fully hereinafter with reference to the accompanying drawings, which form a part hereof, and which show, by way of illustration, specific exemplary embodiments by which the invention may be practiced. The embodiments may, however, be embodied in many different forms and should not be construed as limited to the embodiments set forth herein; rather, these embodiments are provided so that this disclosure will be thorough and complete, and will fully convey the scope of the embodiments to those skilled in the art. Among other things, the various embodiments may be methods, systems, media or devices. Accordingly, the various embodiments may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

For example embodiments, the following terms are also used herein according to the corresponding meaning, unless the context clearly dictates otherwise.

As used herein the term, “engine” refers to logic embodied in hardware or software instructions, which can be written in a programming language, such as C, C++, Objective-C, COBOL, Java™, PHP, Perl, JavaScript, Ruby, VBScript, Microsoft .NET™ languages such as C#, or the like. An engine may be compiled into executable programs or written in interpreted programming languages. Software engines may be callable from other engines or from themselves. Engines described herein refer to one or more logical modules that can be merged with other engines or applications, or can be divided into sub-engines. The engines can be stored in non-transitory computer-readable medium or computer storage device and be stored on and executed by one or more general purpose computers, thus creating a special purpose computer configured to provide the engine.

As used herein the terms “file system object,” or “object” refer to entities stored in a file system. These may include files, directories, or the like. In this document for brevity and clarity all objects stored in a file system may be referred to as file system objects.

As used herein the terms “block,” or “file system object block” refer to the file system data objects that comprise a file system object. For example, small sized file system objects, such as, directory objects or small files may be comprised of a single block. Whereas, larger file system objects, such as large document files may be comprised of many blocks. Blocks usually are arranged to have a fixed size to simplify the management of a file system. This may include fixing blocks to a particular size based on requirements associated with underlying storage hardware, such as, solid state drives (SSDs) or hard disk drives (HDDs), or the like. However, file system objects, such as, files may be of various sizes, comprised of the number of blocks necessary to represent or contain the entire file system object.

As used herein the terms “epoch,” or “file system epoch” refer to time periods in the life of a file system. Epochs may be generated sequentially such that epoch 1 comes before epoch 2 in time. Prior epochs are bounded in the sense that they have a defined beginning and end. The current epoch has a beginning but not an end because it is still running. Epochs may be used to track the birth and death of file system objects, or the like.

As used herein the term “snapshot” refers to a point time version of the file system or a portion of the file system. Snapshots preserve the version of the file system objects at the time the snapshot was taken. In some cases, snapshots may be sequentially labeled such that snapshot 1 is the first snapshot taken in a file system and snapshot 2 is the second snapshot, and so on. The sequential labeling may be file system-wide even though snapshots may cover the same or different portions of the file system. Snapshots demark the end of the current file system epoch and the beginning of the next file system epoch. Accordingly, in some embodiments, if a file system is arranged to count epochs and snapshots sequentially, the epoch value or its number label may be assumed to be greater than the number label of the newest snapshot. Epoch boundaries may be formed if a snapshot is taken. The epoch (e.g., epoch count value) may be incremented if a snapshot is created. Each epoch boundary is created when a snapshot was created. In some cases, if a new snapshot is created, it may be assigned a number label that has the same as the epoch it is closing and thus be one less than the new current epoch that begins running when the new snapshot is taken. Note, other formats of snapshots are contemplated as well as. One of ordinary skill in the art will appreciated that snapshots associated with epochs or snapshot numbers as described herein as examples that at least enable or disclose the innovations described herein.

As used herein the term “replication relationship” refers to data structures that define replication relationships between file systems that are arranged such that one of the file system is periodically backed up to the other. The file system being backed up may be considered a source file system. The file system that is receiving the replicated objects from the source file system may be considered the target file system.

As used herein the term “replication snapshot” refers to a snapshot that is generated for a replication job. Replication snapshots may be considered ephemeral snapshots that may be created and managed by the file system as a continuous replication process for replication the data of a source file system onto a target file system. Replication snapshots may be automatically created for replicating data in a source file system to a target file system. Replication snapshots may be automatically discarded if they are successfully copied to the target file system.

As used herein the term “replication job” refers to one or more actions executed by a replication engine to create a replication snapshot and copy it to the target file system. A replication job may be associated with one replication snapshot.

As used herein the term “snapshot copy job,” or “copy job” refers to one or more actions executed by a replication engine to copy point-in-time snapshots associated with a replication relationship to a target file system.

As used herein the term “configuration information” refers to information that may include rule based policies, pattern matching, scripts (e.g., computer readable instructions), or the like, that may be provided from various sources, including, configuration files, databases, user input, built-in defaults, or the like, or combination thereof.

The following briefly describes embodiments of the invention in order to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated, various embodiments are directed to managing data in a file system over a network. In one or more of the various embodiments, a source file system and a target file system associated based on a replication relationship may be provided such that the replication relationship is associated with one or more snapshot policies.

In one or more of the various embodiments, one or more snapshots may be generated on the source file system based on the one or more snapshot policies such that each snapshot is a point-in-time archive of a state of a same portion of the source file system.

In one or more of the various embodiments, the one or more snapshots may be added to a queue on the source file system that may be associated with the replication relationship such that the snapshot is associated with a snapshot retention period that is local to the source file system. And, in some embodiments, the local snapshot retention period may be provided by a corresponding snapshot policy that may be local to the source file system and a remote replication retention period based on the replication relationship. And, in some embodiments, each snapshot in the queue may be ordered based on a time of creation of each snapshot on the source file system.

In one or more of the various embodiments, a snapshot that may be in a first position in the queue may be determined based on the time of creation such that further actions may be performed for the determined snapshot, including: in response to the local snapshot retention period and the remote replication retention period being expired, copying the snapshot to the target file system; in response to the local snapshot retention period being expired and the remote replication retention period being unexpired, copying the snapshot to the target file system; and in response to the local snapshot retention period being expired and the remote replication retention period being expired, discarding the snapshot. Also, in some embodiments, in response to the local snapshot retention period being unexpired and the remote replication retention period being expired, removing the snapshot from the queue.

In one or more of the various embodiments, a replication snapshot on the source file system that may be separate from the one or more snapshots may be generated; executing a replication job to copy the replication snapshot from the source file system to the target file system; and in response to the one or more snapshots being in the queue, performing further actions, including: pausing the execution of the replication job; copying the one or more snapshots to the target file system; and unpausing the execution of the replication job.

In one or more of the various embodiments, copying snapshots to the target file system, may include: in response to an error condition that interferes with the copying of the snapshot to the target file system, further actions may be performed, including: pausing the copying of the snapshot to the target file system; and resuming the copying of the snapshot to the target file system such that one or more portions of the snapshot that may be on the target file system may be omitted from copying.

In one or more of the various embodiments, providing one or more other replication relationships on the source file system such that each other replication relationship may be associated with a dedicated queue that may be separate from the queue. And, in some embodiments, the one or more snapshot policies may be associated with each other replication relationship such that one or more different remote retention periods may be provided by the one or more other replication relationships.

In one or more of the various embodiments, one or more source storage systems may be provided for the source file system. And, in some embodiments, one or more target storage systems may be provided for the target file system such that the one or more source storage systems may be associated with higher performance and higher cost than the target storage systems.

In one or more of the various embodiments, one or more blackout periods that are associated with the replication relationship may be provided such that copying the one or more snapshot in queue may be paused during the one or more blackout periods.

### Illustrated Operating Environment

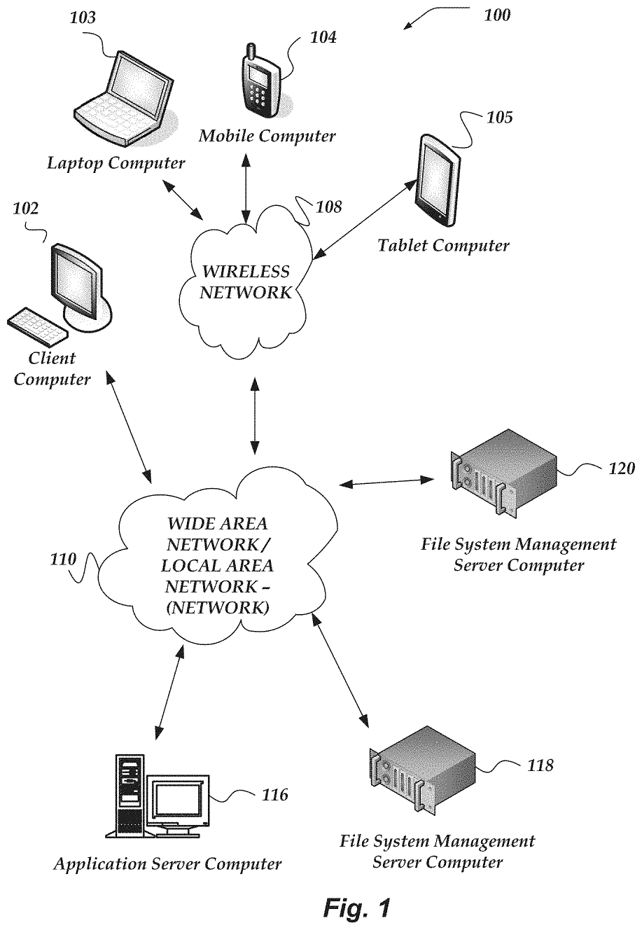

FIG. 1 shows components of one embodiment of an environment in which embodiments of the invention may be practiced. Not all of the components may be required to practice the invention, and variations in the arrangement and type of the components may be made without departing from the spirit or scope of the invention. As shown, system 100 of FIG. 1 includes local area networks (LANs)/wide area networks (WANs)—(network) 110, wireless network 108, client computers 102-105, application server computer 116, file system management server computer 118, file system management server computer 120, or the like.

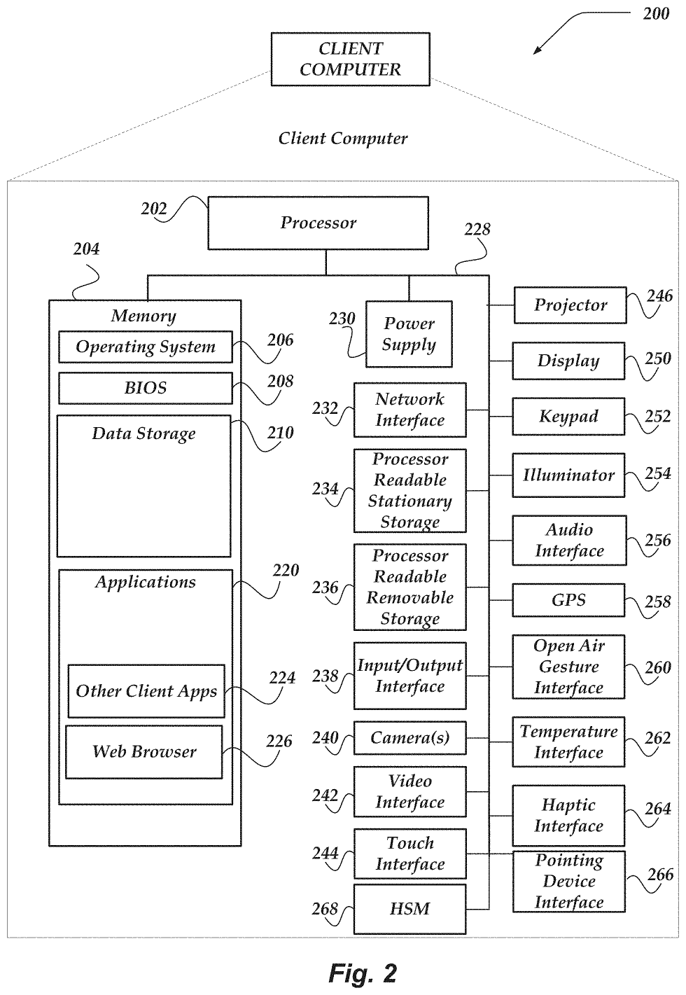

At least one embodiment of client computers 102-105 is described in more detail below in conjunction with FIG. 2. In one embodiment, at least some of client computers 102-105 may operate over one or more wired or wireless networks, such as networks 108, or 110. Generally, client computers 102-105 may include virtually any computer capable of communicating over a network to send and receive information, perform various online activities, offline actions, or the like. In one embodiment, one or more of client computers 102-105 may be configured to operate within a business or other entity to perform a variety of services for the business or other entity. For example, client computers 102-105 may be configured to operate as a web server, firewall, client application, media player, mobile telephone, game console, desktop computer, or the like. However, client computers 102-105 are not constrained to these services and may also be employed, for example, as for end-user computing in other embodiments. It should be recognized that more or less client computers (as shown in FIG. 1) may be included within a system such as described herein, and embodiments are therefore not constrained by the number or type of client computers employed.

Computers that may operate as client computer 102 may include computers that typically connect using a wired or wireless communications medium such as personal computers, multiprocessor systems, microprocessor-based or programmable electronic devices, network PCs, or the like. In some embodiments, client computers 102-105 may include virtually any portable computer capable of connecting to another computer and receiving information such as, laptop computer 103, mobile computer 104, tablet computers 105, or the like. However, portable computers are not so limited and may also include other portable computers such as cellular telephones, display pagers, radio frequency (RF) devices, infrared (IR) devices, Personal Digital Assistants (PDAs), handheld computers, wearable computers, integrated devices combining one or more of the preceding computers, or the like. As such, client computers 102-105 typically range widely in terms of capabilities and features. Moreover, client computers 102-105 may access various computing applications, including a browser, or other web-based application.

A web-enabled client computer may include a browser application that is configured to send requests and receive responses over the web. The browser application may be configured to receive and display graphics, text, multimedia, and the like, employing virtually any web-based language. In one embodiment, the browser application is enabled to employ JavaScript, HyperText Markup Language (HTML), eXtensible Markup Language (XML), JavaScript Object Notation (JSON), Cascading Style Sheets (CSS), or the like, or combination thereof, to display and send a message. In one embodiment, a user of the client computer may employ the browser application to perform various activities over a network (online). However, another application may also be used to perform various online activities.

Client computers 102-105 also may include at least one other client application that is configured to receive or send content between another computer. The client application may include a capability to send or receive content, or the like. The client application may further provide information that identifies itself, including a type, capability, name, and the like. In one embodiment, client computers 102-105 may uniquely identify themselves through any of a variety of mechanisms, including an Internet Protocol (IP) address, a phone number, Mobile Identification Number (MIN), an electronic serial number (ESN), a client certificate, or other device identifier. Such information may be provided in one or more network packets, or the like, sent between other client computers, application server computer 116, file system management server computer 118, file system management server computer 120, or other computers.

Client computers 102-105 may further be configured to include a client application that enables an end-user to log into an end-user account that may be managed by another computer, such as application server computer 116, file system management server computer 118, file system management server computer 120, or the like. Such an end-user account, in one non-limiting example, may be configured to enable the end-user to manage one or more online activities, including in one non-limiting example, project management, software development, system administration, configuration management, search activities, social networking activities, browse various websites, communicate with other users, or the like. Also, client computers may be arranged to enable users to display reports, interactive user-interfaces, or results provided by application server computer 116, file system management server computer 118, file system management server computer 120.

Wireless network 108 is configured to couple client computers 103-105 and its components with network 110. Wireless network 108 may include any of a variety of wireless sub-networks that may further overlay stand-alone ad-hoc networks, and the like, to provide an infrastructure-oriented connection for client computers 103-105. Such sub-networks may include mesh networks, Wireless LAN (WLAN) networks, cellular networks, and the like. In one embodiment, the system may include more than one wireless network.

Wireless network 108 may further include an autonomous system of terminals, gateways, routers, and the like connected by wireless radio links, and the like. These connectors may be configured to move freely and randomly and organize themselves arbitrarily, such that the topology of wireless network 108 may change rapidly.

Wireless network 108 may further employ a plurality of access technologies including 2nd (2G), 3rd (3G), 4th (4G) 5th (5G) generation radio access for cellular systems, WLAN, Wireless Router (WR) mesh, and the like. Access technologies such as 2G, 3G, 4G, 5G, and future access networks may enable wide area coverage for mobile computers, such as client computers 103-105 with various degrees of mobility. In one non-limiting example, wireless network 108 may enable a radio connection through a radio network access such as Global System for Mobil communication (GSM), General Packet Radio Services (GPRS), Enhanced Data GSM Environment (EDGE), code division multiple access (CDMA), time division multiple access (TDMA), Wideband Code Division Multiple Access (WCDMA), High Speed Downlink Packet Access (HSDPA), Long Term Evolution (LTE), and the like. In essence, wireless network 108 may include virtually any wireless communication mechanism by which information may travel between client computers 103-105 and another computer, network, a cloud-based network, a cloud instance, or the like.

Network 110 is configured to couple network computers with other computers, including, application server computer 116, file system management server computer 118, file system management server computer 120, client computers 102, and client computers 103-105 through wireless network 108, or the like. Network 110 is enabled to employ any form of computer readable media for communicating information from one electronic device to another. Also, network 110 can include the Internet in addition to local area networks (LANs), wide area networks (WANs), direct connections, such as through a universal serial bus (USB) port, Ethernet port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, or other carrier mechanisms including, for example, E-carriers, Integrated Services Digital Networks (ISDNs), Digital Subscriber Lines (DSLs), wireless links including satellite links, or other communications links known to those skilled in the art. Moreover, communication links may further employ any of a variety of digital signaling technologies, including without limit, for example, DS-0, DS-1, DS-2, DS-3, DS-4, OC-3, OC-12, OC-48, or the like. Furthermore, remote computers and other related electronic devices could be remotely connected to either LANs or WANs via a modem and temporary telephone link. In one embodiment, network 110 may be configured to transport information of an Internet Protocol (IP).

Additionally, communication media typically embodies computer readable instructions, data structures, program modules, or other transport mechanism and includes any information non-transitory delivery media or transitory delivery media. By way of example, communication media includes wired media such as twisted pair, coaxial cable, fiber optics, wave guides, and other wired media and wireless media such as acoustic, RF, infrared, and other wireless media.

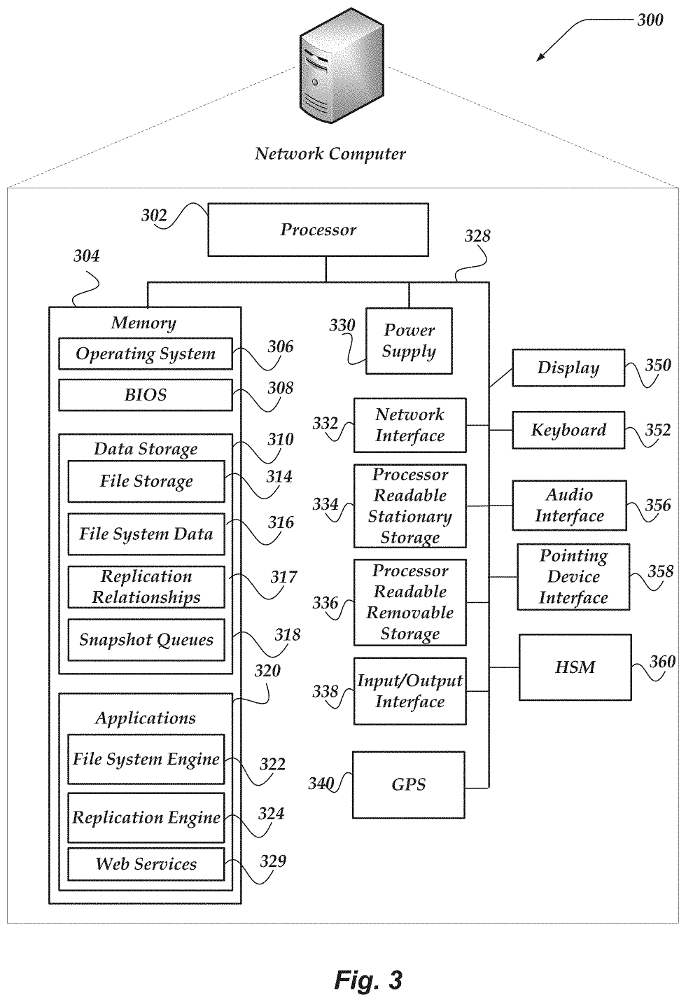

Also, one embodiment of file system management server computer 118 or file system management server computer 120 are described in more detail below in conjunction with FIG. 3. Although FIG. 1 illustrates file system management server computer 118 or file system management server computer 120, or the like, each as a single computer, the innovations or embodiments are not so limited. For example, one or more functions of file system management server computer 118 or file system management server computer 120, or the like, may be distributed across one or more distinct network computers. Moreover, in one or more embodiments, file system management server computer 118 or file system management server computer 120 may be implemented using a plurality of network computers. Further, in one or more of the various embodiments, file system management server computer 118 or file system management server computer 120, or the like, may be implemented using one or more cloud instances in one or more cloud networks. Accordingly, these innovations and embodiments are not to be construed as being limited to a single environment, and other configurations, and other architectures are also envisaged.

### Illustrative Client Computer

FIG. 2 shows one embodiment of client computer 200 that may include many more or less components than those shown. Client computer 200 may represent, for example, one or more embodiment of mobile computers or client computers shown in FIG. 1.

Client computer 200 may include processor 202 in communication with memory 204 via bus 228. Client computer 200 may also include power supply 230, network interface 232, audio interface 256, display 250, keypad 252, illuminator 254, video interface 242, input/output interface 238, haptic interface 264, global positioning systems (GPS) receiver 258, open air gesture interface 260, temperature interface 262, camera(s) 240, projector 246, pointing device interface 266, processor-readable stationary storage device 234, and processor-readable removable storage device 236. Client computer 200 may optionally communicate with a base station (not shown), or directly with another computer. And in one embodiment, although not shown, a gyroscope may be employed within client computer 200 to measuring or maintaining an orientation of client computer 200.

Power supply 230 may provide power to client computer 200. A rechargeable or non-rechargeable battery may be used to provide power. The power may also be provided by an external power source, such as an AC adapter or a powered docking cradle that supplements or recharges the battery.

Network interface 232 includes circuitry for coupling client computer 200 to one or more networks, and is constructed for use with one or more communication protocols and technologies including, but not limited to, protocols and technologies that implement any portion of the OSI model for mobile communication (GSM), CDMA, time division multiple access (TDMA), UDP, TCP/IP, SMS, MMS, GPRS, WAP, UWB, WiMax, SIP/RTP, GPRS, EDGE, WCDMA, LTE, UMTS, OFDM, CDMA2000, EV-DO, HSDPA, 5G, or any of a variety of other wireless communication protocols. Network interface 232 is sometimes known as a transceiver, transceiving device, or network interface card (MC).

Audio interface 256 may be arranged to produce and receive audio signals such as the sound of a human voice. For example, audio interface 256 may be coupled to a speaker and microphone (not shown) to enable telecommunication with others or generate an audio acknowledgment for some action. A microphone in audio interface 256 can also be used for input to or control of client computer 200, e.g., using voice recognition, detecting touch based on sound, and the like.

Display 250 may be a liquid crystal display (LCD), gas plasma, electronic ink, light emitting diode (LED), Organic LED (OLED) or any other type of light reflective or light transmissive display that can be used with a computer. Display 250 may also include a touch interface 244 arranged to receive input from an object such as a stylus or a digit from a human hand, and may use resistive, capacitive, surface acoustic wave (SAW), infrared, radar, or other technologies to sense touch or gestures.

Projector 246 may be a remote handheld projector or an integrated projector that is capable of projecting an image on a remote wall or any other reflective object such as a remote screen.

Video interface 242 may be arranged to capture video images, such as a still photo, a video segment, an infrared video, or the like. For example, video interface 242 may be coupled to a digital video camera, a web-camera, or the like. Video interface 242 may comprise a lens, an image sensor, and other electronics. Image sensors may include a complementary metal-oxide-semiconductor (CMOS) integrated circuit, charge-coupled device (CCD), or any other integrated circuit for sensing light.

Keypad 252 may comprise any input device arranged to receive input from a user. For example, keypad 252 may include a push button numeric dial, or a keyboard. Keypad 252 may also include command buttons that are associated with selecting and sending images.

Illuminator 254 may provide a status indication or provide light. Illuminator 254 may remain active for specific periods of time or in response to event messages. For example, when illuminator 254 is active, it may back-light the buttons on keypad 252 and stay on while the client computer is powered. Also, illuminator 254 may back-light these buttons in various patterns when particular actions are performed, such as dialing another client computer. Illuminator 254 may also cause light sources positioned within a transparent or translucent case of the client computer to illuminate in response to actions.

Further, client computer 200 may also comprise hardware security module (HSM) 268 for providing additional tamper resistant safeguards for generating, storing or using security/cryptographic information such as, keys, digital certificates, passwords, passphrases, two-factor authentication information, or the like. In some embodiments, hardware security module may be employed to support one or more standard public key infrastructures (PKI), and may be employed to generate, manage, or store keys pairs, or the like. In some embodiments, HSM 268 may be a stand-alone computer, in other cases, HSM 268 may be arranged as a hardware card that may be added to a client computer.

Client computer 200 may also comprise input/output interface 238 for communicating with external peripheral devices or other computers such as other client computers and network computers. The peripheral devices may include an audio headset, virtual reality headsets, display screen glasses, remote speaker system, remote speaker and microphone system, and the like. Input/output interface 238 can utilize one or more technologies, such as Universal Serial Bus (USB), Infrared, WiFi, WiMax, Bluetooth™, and the like.

Input/output interface 238 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like. Sensors may be one or more hardware sensors that collect or measure data that is external to client computer 200.

Haptic interface 264 may be arranged to provide tactile feedback to a user of the client computer. For example, the haptic interface 264 may be employed to vibrate client computer 200 in a particular way when another user of a computer is calling. Temperature interface 262 may be used to provide a temperature measurement input or a temperature changing output to a user of client computer 200. Open air gesture interface 260 may sense physical gestures of a user of client computer 200, for example, by using single or stereo video cameras, radar, a gyroscopic sensor inside a computer held or worn by the user, or the like. Camera 240 may be used to track physical eye movements of a user of client computer 200.

GPS transceiver 258 can determine the physical coordinates of client computer 200 on the surface of the Earth, which typically outputs a location as latitude and longitude values. GPS transceiver 258 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of client computer 200 on the surface of the Earth. It is understood that under different conditions, GPS transceiver 258 can determine a physical location for client computer 200. In one or more embodiments, however, client computer 200 may, through other components, provide other information that may be employed to determine a physical location of the client computer, including for example, a Media Access Control (MAC) address, IP address, and the like.

In at least one of the various embodiments, applications, such as, operating system 206, other client apps 224, web browser 226, or the like, may be arranged to employ geo-location information to select one or more localization features, such as, time zones, languages, currencies, calendar formatting, or the like. Localization features may be used in display objects, data models, data objects, user-interfaces, reports, as well as internal processes or databases. In at least one of the various embodiments, geo-location information used for selecting localization information may be provided by GPS 258. Also, in some embodiments, geolocation information may include information provided using one or more geolocation protocols over the networks, such as, wireless network 108 or network 111.

Human interface components can be peripheral devices that are physically separate from client computer 200, allowing for remote input or output to client computer 200. For example, information routed as described here through human interface components such as display 250 or keyboard 252 can instead be routed through network interface 232 to appropriate human interface components located remotely. Examples of human interface peripheral components that may be remote include, but are not limited to, audio devices, pointing devices, keypads, displays, cameras, projectors, and the like. These peripheral components may communicate over a Pico Network such as Bluetooth™, Zigbee™ and the like. One non-limiting example of a client computer with such peripheral human interface components is a wearable computer, which might include a remote pico projector along with one or more cameras that remotely communicate with a separately located client computer to sense a user's gestures toward portions of an image projected by the pico projector onto a reflected surface such as a wall or the user's hand.

A client computer may include web browser application 226 that is configured to receive and to send web pages, web-based messages, graphics, text, multimedia, and the like. The client computer's browser application may employ virtually any programming language, including a wireless application protocol messages (WAP), and the like. In one or more embodiments, the browser application is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), HTML5, and the like.

Memory 204 may include RAM, ROM, or other types of memory. Memory 204 illustrates an example of computer-readable storage media (devices) for storage of information such as computer-readable instructions, data structures, program modules or other data. Memory 204 may store BIOS 208 for controlling low-level operation of client computer 200. The memory may also store operating system 206 for controlling the operation of client computer 200. It will be appreciated that this component may include a general-purpose operating system such as a version of UNIX, or LINUX™, or a specialized client computer communication operating system such as Windows Phone™, or the Symbian® operating system. The operating system may include, or interface with a Java virtual machine module that enables control of hardware components or operating system operations via Java application programs.

Memory 204 may further include one or more data storage 210, which can be utilized by client computer 200 to store, among other things, applications 220 or other data. For example, data storage 210 may also be employed to store information that describes various capabilities of client computer 200. The information may then be provided to another device or computer based on any of a variety of methods, including being sent as part of a header during a communication, sent upon request, or the like. Data storage 210 may also be employed to store social networking information including address books, buddy lists, aliases, user profile information, or the like. Data storage 210 may further include program code, data, algorithms, and the like, for use by a processor, such as processor 202 to execute and perform actions. In one embodiment, at least some of data storage 210 might also be stored on another component of client computer 200, including, but not limited to, non-transitory processor-readable removable storage device 236, processor-readable stationary storage device 234, or even external to the client computer.

Applications 220 may include computer executable instructions which, when executed by client computer 200, transmit, receive, or otherwise process instructions and data. Applications 220 may include, for example, client user interface engine 222, other client applications 224, web browser 226, or the like. Client computers may be arranged to exchange communications one or more servers.

Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, visualization applications, and so forth.

Additionally, in one or more embodiments (not shown in the figures), client computer 200 may include an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. Also, in one or more embodiments (not shown in the figures), client computer 200 may include one or more hardware micro-controllers instead of CPUs. In one or more embodiments, the one or more micro-controllers may directly execute their own embedded logic to perform actions and access its own internal memory and its own external Input and Output Interfaces (e.g., hardware pins or wireless transceivers) to perform actions, such as System On a Chip (SOC), or the like.

### Illustrative Network Computer

FIG. 3 shows one embodiment of network computer 300 that may be included in a system implementing one or more of the various embodiments. Network computer 300 may include many more or less components than those shown in FIG. 3. However, the components shown are sufficient to disclose an illustrative embodiment for practicing these innovations. Network computer 300 may represent, for example, one or more embodiments of a file system management server computer such as file system management server computer 118, or the like, of FIG. 1.

Network computers, such as, network computer 300 may include a processor 302 that may be in communication with a memory 304 via a bus 328. In some embodiments, processor 302 may be comprised of one or more hardware processors, or one or more processor cores. In some cases, one or more of the one or more processors may be specialized processors designed to perform one or more specialized actions, such as, those described herein. Network computer 300 also includes a power supply 330, network interface 332, audio interface 356, display 350, keyboard 352, input/output interface 338, processor-readable stationary storage device 334, and processor-readable removable storage device 336. Power supply 330 provides power to network computer 300.

Network interface 332 includes circuitry for coupling network computer 300 to one or more networks, and is constructed for use with one or more communication protocols and technologies including, but not limited to, protocols and technologies that implement any portion of the Open Systems Interconnection model (OSI model), global system for mobile communication (GSM), code division multiple access (CDMA), time division multiple access (TDMA), user datagram protocol (UDP), transmission control protocol/Internet protocol (TCP/IP), Short Message Service (SMS), Multimedia Messaging Service (MMS), general packet radio service (GPRS), WAP, ultra-wide band (UWB), IEEE 802.16 Worldwide Interoperability for Microwave Access (WiMax), Session Initiation Protocol/Real-time Transport Protocol (SIP/RTP), 5G, or any of a variety of other wired and wireless communication protocols. Network interface 332 is sometimes known as a transceiver, transceiving device, or network interface card (NIC). Network computer 300 may optionally communicate with a base station (not shown), or directly with another computer.

Audio interface 356 is arranged to produce and receive audio signals such as the sound of a human voice. For example, audio interface 356 may be coupled to a speaker and microphone (not shown) to enable telecommunication with others or generate an audio acknowledgment for some action. A microphone in audio interface 356 can also be used for input to or control of network computer 300, for example, using voice recognition.

Display 350 may be a liquid crystal display (LCD), gas plasma, electronic ink, light emitting diode (LED), Organic LED (OLED) or any other type of light reflective or light transmissive display that can be used with a computer. In some embodiments, display 350 may be a handheld projector or pico projector capable of projecting an image on a wall or other object.

Network computer 300 may also comprise input/output interface 338 for communicating with external devices or computers not shown in FIG. 3. Input/output interface 338 can utilize one or more wired or wireless communication technologies, such as USB™, Firewire™, WiFi, WiMax, Thunderbolt™, Infrared, Bluetooth™, Zigbee™, serial port, parallel port, and the like.

Also, input/output interface 338 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like. Sensors may be one or more hardware sensors that collect or measure data that is external to network computer 300. Human interface components can be physically separate from network computer 300, allowing for remote input or output to network computer 300. For example, information routed as described here through human interface components such as display 350 or keyboard 352 can instead be routed through the network interface 332 to appropriate human interface components located elsewhere on the network. Human interface components include any component that allows the computer to take input from, or send output to, a human user of a computer. Accordingly, pointing devices such as mice, styluses, track balls, or the like, may communicate through pointing device interface 358 to receive user input.

GPS transceiver 340 can determine the physical coordinates of network computer 300 on the surface of the Earth, which typically outputs a location as latitude and longitude values. GPS transceiver 340 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of network computer 300 on the surface of the Earth. It is understood that under different conditions, GPS transceiver 340 can determine a physical location for network computer 300. In one or more embodiments, however, network computer 300 may, through other components, provide other information that may be employed to determine a physical location of the client computer, including for example, a Media Access Control (MAC) address, IP address, and the like.

In at least one of the various embodiments, applications, such as, operating system 306, file system engine 322, replication engine 324, web services 329, or the like, may be arranged to employ geo-location information to select one or more localization features, such as, time zones, languages, currencies, currency formatting, calendar formatting, or the like. Localization features may be used in user interfaces, dashboards, reports, as well as internal processes or databases. In at least one of the various embodiments, geo-location information used for selecting localization information may be provided by GPS 340. Also, in some embodiments, geolocation information may include information provided using one or more geolocation protocols over the networks, such as, wireless network 108 or network 111.

Memory 304 may include Random Access Memory (RAM), Read-Only Memory (ROM), or other types of memory. Memory 304 illustrates an example of computer-readable storage media (devices) for storage of information such as computer-readable instructions, data structures, program modules or other data. Memory 304 stores a basic input/output system (BIOS) 308 for controlling low-level operation of network computer 300. The memory also stores an operating system 306 for controlling the operation of network computer 300. It will be appreciated that this component may include a general-purpose operating system such as a version of UNIX, or Linux®, or a specialized operating system such as Microsoft Corporation's Windows® operating system, or the Apple Corporation's macOS® operating system. The operating system may include, or interface with one or more virtual machine modules, such as, a Java virtual machine module that enables control of hardware components or operating system operations via Java application programs. Likewise, other runtime environments may be included.

Memory 304 may further include one or more data storage 310, which can be utilized by network computer 300 to store, among other things, applications 320 or other data. For example, data storage 310 may also be employed to store information that describes various capabilities of network computer 300. The information may then be provided to another device or computer based on any of a variety of methods, including being sent as part of a header during a communication, sent upon request, or the like. Data storage 310 may also be employed to store social networking information including address books, friend lists, aliases, user profile information, or the like. Data storage 310 may further include program code, data, algorithms, and the like, for use by a processor, such as processor 302 to execute and perform actions such as those actions described below. In one embodiment, at least some of data storage 310 might also be stored on another component of network computer 300, including, but not limited to, non-transitory media inside processor-readable removable storage device 336, processor-readable stationary storage device 334, or any other computer-readable storage device within network computer 300, or even external to network computer 300. Data storage 310 may include, for example, file storage 314, file system data 316, replication relationships 317, snapshot queues 318, or the like.

Applications 320 may include computer executable instructions which, when executed by network computer 300, transmit, receive, or otherwise process messages (e.g., SMS, Multimedia Messaging Service (MMS), Instant Message (IM), email, or other messages), audio, video, and enable telecommunication with another user of another mobile computer. Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth. Applications 320 may include file system engine 322, replication engine 324, web services 329, or the like, that may be arranged to perform actions for embodiments described below. In one or more of the various embodiments, one or more of the applications may be implemented as modules or components of another application. Further, in one or more of the various embodiments, applications may be implemented as operating system extensions, modules, plugins, or the like.

Furthermore, in one or more of the various embodiments, file system engine 322, replication engine 324, web services 329, or the like, may be operative in a cloud-based computing environment. In one or more of the various embodiments, these applications, and others, that comprise the management platform may be executing within virtual machines or virtual servers that may be managed in a cloud-based based computing environment. In one or more of the various embodiments, in this context the applications may flow from one physical network computer within the cloud-based environment to another depending on performance and scaling considerations automatically managed by the cloud computing environment. Likewise, in one or more of the various embodiments, virtual machines or virtual servers dedicated to file system engine 322, replication engine 324, web services 329, or the like, may be provisioned and de-commissioned automatically.

Also, in one or more of the various embodiments, file system engine 322, replication engine 324, web services 329, or the like, may be located in virtual servers running in a cloud-based computing environment rather than being tied to one or more specific physical network computers.

Further, network computer 300 may also comprise hardware security module (HSM) 360 for providing additional tamper resistant safeguards for generating, storing or using security/cryptographic information such as, keys, digital certificates, passwords, passphrases, two-factor authentication information, or the like. In some embodiments, hardware security module may be employ to support one or more standard public key infrastructures (PKI), and may be employed to generate, manage, or store keys pairs, or the like. In some embodiments, HSM 360 may be a stand-alone network computer, in other cases, HSM 360 may be arranged as a hardware card that may be installed in a network computer.

Additionally, in one or more embodiments (not shown in the figures), network computer 300 may include an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. Also, in one or more embodiments (not shown in the figures), the network computer may include one or more hardware microcontrollers instead of a CPU. In one or more embodiments, the one or more microcontrollers may directly execute their own embedded logic to perform actions and access their own internal memory and their own external Input and Output Interfaces (e.g., hardware pins or wireless transceivers) to perform actions, such as System On a Chip (SOC), or the like.

### Illustrative Logical System Architecture

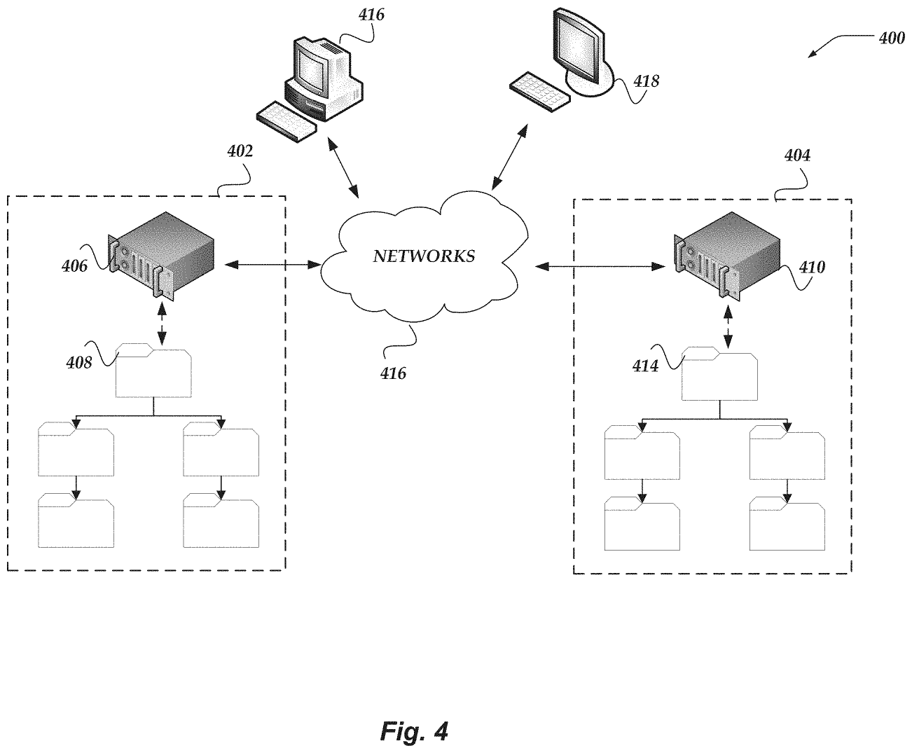

FIG. 4 illustrates a logical architecture of system 400 for managing cluster to cluster replication for distributed file systems in accordance with one or more of the various embodiments. In one or more of the various embodiments, two or more file systems, such as, file system 402 and file system 404 may be arranged to be communicatively coupled to one or more networks, such as, networks 416. Accordingly, in one or more of the various embodiments, one or more clients, such as, client computer 416 and client computer 418 may be arranged to access file system 402 or file system 404 over networks 416. In some embodiments, clients of file system 402 or file system 404 may include users, services, programs, computers, devices, or the like, that may be enabled to perform one or more file system operations, such as, creating, reading, updating, or deleting data (e.g., file system objects) that may be stored in file system 402 or file system 404. In some embodiments, file system 402 or file system 404 may comprise one or more file system management computers, such as file system management computer 406 or file system management computer 410. Also, in one or more of the various embodiments, file systems, such as file system 402 or file system 404 may include one or more file system objects, such as file system object 408 or file system object 414. file system object 412 or file system object 414 may represent the various objects or entities that may be stored in file system 402 or file system 404. In some embodiments, file system objects may include, files, documents, directories, folders, change records, backups, snapshots, replication snapshots, replication information, or the like.

In one or more of the various embodiments, the implementation details that enable file system 402 or file system 404 to operate may be hidden from clients, such that they may be arranged to use file system 402 or file system 404 the same way they use other conventional file systems, including local file systems. Accordingly, in one or more of the various embodiments, clients may be unaware that they are using a distributed file system that supports replicating file objects to other file systems because file system engines or replication engines may be arranged to mimic the interface or behavior of one or more standard file systems.

Also, while file system 402 and file system 404 are illustrated as using one file system management computer each with one set of file system objects, the innovations are not so limited. Innovations herein contemplate file systems that include one or more file system management computers or one or more file system object data stores. In some embodiments, file system object stores may be located remotely from one or more file system management computers. Also, a logical file system object store or file system may be spread across two or more cloud computing environments, storage clusters, or the like.

In some embodiments, one or more replication engines, such as, replication engine 324 may be running on a file system management computer, such as, file system management computer 406 or file system management computer 410. In some embodiments, replication engines may be arranged to perform actions to replicate of one or more portions of one or more file systems.

In one or more of the various embodiments, it may be desirable to configure file systems, such as, file system 402 to be replicated onto one or more different file systems, such as, file system 404. Accordingly, upon being triggered (e.g., via schedules, user input, continuous replication, or the like), a replication engine running on a source file system, such as, file system 402 may be arranged to replicate its file system objects on one or more target file systems, such as, file system 404.

In one or more of the various embodiments, replication engines may be arranged to enable users to determine one or more portions of a source file system to replicate on a target file system. Accordingly, in some embodiments, replication engines may be arranged to provide one or more replication relationships that define which portions of a source file system, if any, should have its data replicated on the target file system.

In one or more of the various embodiments, file systems may be associated with replication relationships such that a one or more portions of a source file system may be configured to automatically be replicated on a target file system. Accordingly, in one or more of the various embodiments, replication engines may execute replication jobs that copy changes from the source file system to the target file system. In some embodiments, replication engines may be arranged to copy file system objects that have been added or modified to the source file system since the previous replication job.

In one or more of the various embodiments, one or more replication relationships may be configured to provide continuous replication from source file systems to target file systems. In some embodiments, if continuous replication may be activated for a replication relationship, the replication engine may be arranged to start the next replication job periodically. Alternatively, in some embodiments, replication engines configured for continuous replication may start the next replication job as soon as the previous replication job has completed.

In one or more of the various embodiments, replication jobs may be arranged to mirror file system objects or data from the source file system on the target file system. Accordingly, in some embodiments, replicated file systems (e.g., target file system) may mirror the data of the source file system at the time of the replication. However, in some embodiments, organizations may want to generate and preserve point-in-time versions of file systems. Thus, in some embodiments, while replication jobs may preserve the current data of the source file system, they do not preserve point-in-time versions of the file system.

Accordingly, in some embodiments, replication engines may be arranged to enable organizations to define snapshot policies that include one or more rules for generating point-in-time snapshots of one or more portions of the source file systems. However, in some embodiments, while replication jobs may copy the current versions of the file system objects on source file systems to target file systems they may be disabled from automatically copying other point-in-time snapshots because they are not strictly representative of the current state of the source file system.

In some embodiments, replication engines may be arranged to extent replication relationships to include additional rules or information that enables replication engines to preserve other snapshots generated on a source file. Accordingly, in one or more of the various embodiments, replication engines may be arranged to enable replication relationships to include references to selected snapshot policies associated with snapshots of the source file system. In one or more of the various embodiments, snapshot policies may define various parameters or attributes associated with point in time snapshots that an organization may want to preserve.

In one or more of the various embodiments, snapshot policies may include various parameters, such as, root directory, period/schedule information, blackout windows, retention information, or the like. For example, snapshot policy A may prescribe that a snapshot of directory /data/A/ should be generated every 10 minutes with a retention period of five days. In some embodiments, this example, would cause a replication engine to recursively traverse the file system, starting at directory /data/A/ to identify file system objects that may be preserved and stored locally on the file system. Further, in some embodiments, replication engines may be arranged delete snapshots created for snapshot policies based on the retention period defined by the snapshot policy. Accordingly, in the example above, a replication engine may be arranged to delete snapshots generated under snapshot policy A five days after they are created.

In one or more of the various embodiments, replication engines may be arranged to support or execute one or more snapshot policies for the same file system. Thus, in some embodiments, at any given time, replication engines may generate snapshots at different times for the same or different parts of the same file system. Also, in one or more of the various embodiments, file systems may have one or more snapshots stored locally, each with independent retention rules that may define different expiration times as per the snapshot policies they were created under.

In one or more of the various embodiments, snapshot policies may be configured to name or label snapshots such that the name or label of each snapshot may indicate important information, such as, root directory, schedule, expiration date, or the like. Also, in some embodiments, replication engines may be arranged to enable users to review snapshot policy parameters via a user interface. Likewise, in some embodiments, replication engines may be arranged to provide a user interface that enables users to perform other snapshot related actions, such as, browsing snapshots, deleting snapshots, expanding or inflating snapshots to enable access to the included file system objects.

In one or more of the various embodiments, replication engines may be arranged to enable point-in-time snapshots to preserved based on rules defined in replication relationships. Accordingly, in some embodiments, replication engine may be arranged to enable one or more snapshot policies to be associated with one or more replication relationships. In some embodiments, associating snapshot policies with replication relationships indicates that snapshots associated with the associated snapshot policies may be backed up on target file systems associated with the replication relationships.

In one or more of the various embodiments, if one or more snapshot policies may be associated with a replication relationship, replication engines may be arranged to provide a queue of snapshots generated by the associated snapshot policies. Accordingly, in some embodiments, replication engines generated snapshots based on snapshot policies, snapshot generated under snapshot policies associated with replication relationships may be added to queues for the respective replication relationships in the order the snapshots are created.

Accordingly, in one or more of the various embodiments, replication engines may be arranged to copy the snapshots listed in its queue to the source file system in the order they are listed in the queue. In some embodiments, users may be disabled from modifying the queue ordering. However, in some embodiments, users may be enabled to remove or delete one or more snapshots from the snapshot queue before they have been copied to the target file system. Also, in some embodiments, users may be enabled to abort or cancel a pending snapshot copy job.

In one or more of the various embodiments, replication relationships may be configured to define target retention rules for each snapshot policy that may be different that the retention rules defined by the snapshot policy. For example, for some embodiments, a snapshot policy may define a retention rule that deletes local snapshots every three days. However, in some embodiments, a replication relationship that is associated with the same snapshot policy may define a target retention rule that keeps a copy of the snapshot for 180 days on the target file system.

Accordingly, in some embodiments, organizations may be enabled to avoid long term storage of point-in-time snapshots on expensive storage resources by employing replication relationships to copy one or more snapshots to less expensive (cool or cold storage data stores) to reduce the cost of storing those snapshots for longer time periods.

In some embodiments, replication engines may be arranged to extend the local lifetime of snapshots that may be in a snapshot queue until they have been copied from the source file system to the target file system. For example, for some embodiments, a snapshot that has a local retention period of one hour and a remote retention period of 100 days may have its local lifetime extended until the snapshot may be copied from the source file system to the target file system.

Likewise, In some embodiments, replication engines may be arranged to remove snapshots from the snapshot queue if their remote retention period has expired before they are copied to the target file system. Thus, in some embodiments, replication engines may be arranged to delete such snapshots before they are copied from the source file system to the target file system rather than copying to the target file system where they may be immediately deleted.

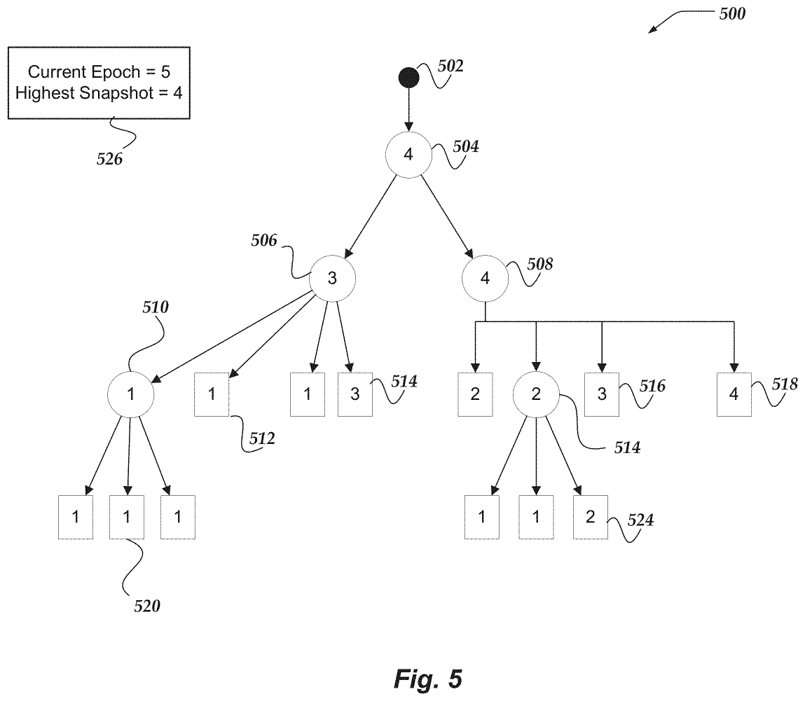

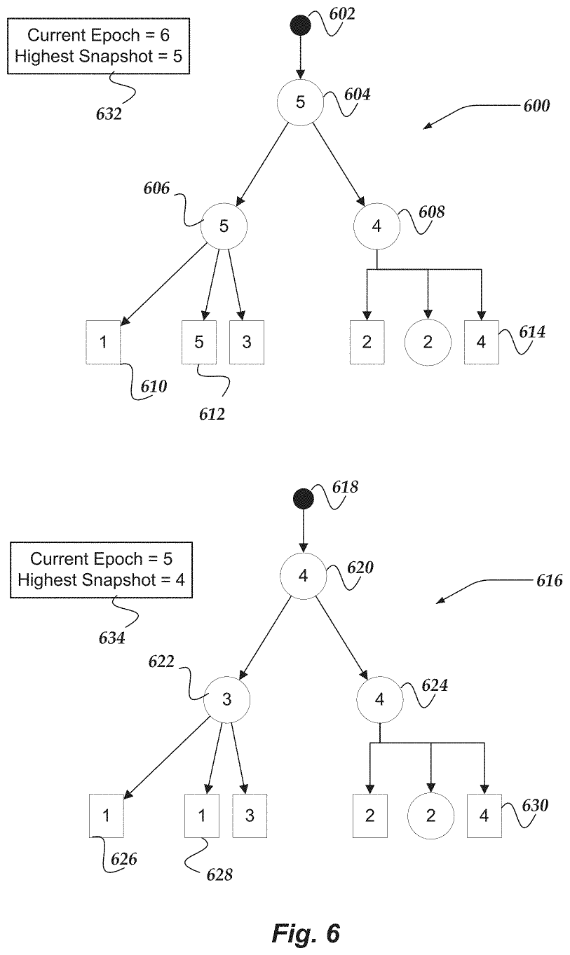

FIG. 5 and FIG. 6 disclose how, one or more of the various embodiments may be arranged to manage or generate snapshots. However, in some embodiments, the innovations described herein are not limited to a particular form or format of snapshots, point-in-time snapshots, or the like. Accordingly, in some embodiments, replication engines may be arranged to replication snapshots generated differently. And, one of ordinary skill in the art will appreciate that file systems may employ various snapshot mechanisms or snapshot facilities. Thus, one of ordinary skill in the art will appreciate that the descriptions below are at least sufficient for disclosing the innovations included herein.

FIG. 5 illustrates a logical representation of file system 500 for managing cluster to cluster replication for distributed file systems in accordance with one or more of the various embodiments. In this example, for clarity and brevity file system 500 is represented as a tree, in practice, various data structures may be used to store the data that represents the tree-like structure of the file system. Data structures may include tabular formats that include keys, self-referencing fields, child-parent relationships, or the like, to implement tree data structures, such as, graphs, trees, or the like, for managing a file system, such as, file system 500.

In this example, circles are used to illustrate directory/folder file system objects. And, rectangles are used to represent other file system objects, such as, files, documents, or the like. The number in the center of the file system object represents the last/latest snapshot associated with the given file system object.

In this example, for some embodiments, root 502 is the beginning of a portion of a file system. Root 502 is not a file system object per se, rather, it indicates a position in a distributed file system. Directory 504 represents the parent file system object of all the objects under root 502. Directory 504 is the parent of directory 506 and directory 508. Directory 510, file object 512, and file object 514 are children of directory 506; directory 514, file object 516, and file object 518 are direct children of directory 508; file object 520 is a direct child of directory 510; and file object 524 is a direct child of directory 514. Also, in this example, for some embodiments, meta-data 526 includes the current update epoch and highest snapshot number for file system 500.

In this example, file system objects in file system 500 are associated with snapshots ranging from snapshot 1 to snapshot 4. The current epoch is number 5. Each time a snapshot is generated, the current epoch is ended and the new snapshot is associated with ending the current epoch. A new current epoch may then be generated by incrementing the last current epoch number. Accordingly, in this example, if another snapshot is generated, it will have a snapshot number of 5 and the current epoch will become epoch 6.

In one or more of the various embodiments, if two or more file systems, such as, file system 500 are arranged for replication, one file system may be designated the source file system and one or more other file systems may be designated target file systems. In some embodiments, the portions of the two or more file systems have the same file system logical structure. In some embodiments, the file systems may have different physical or implementations or representations as long as they logically represent the same structure.

In one or more of the various embodiments, at steady-state, parent file system objects, such as, directory 504, directory 506, directory 508, directory 510, directory 514, or the like, have a snapshot number based on the most recent snapshot associated with any of its children. For example, in this example, directory 504 has a snapshot value of 4 because its descendant, file object 518 has a snapshot value of 4. Similarly, directory 508 has the same snapshot value as file object 518. Continuing with this example, this is because file object 518 was modified or created sometime after snapshot 3 was generated and before snapshot 4 was generated.

In one or more of the various embodiments, if file system objects are not modified subsequent to the generation follow-on snapshots, they remain associated with their current/last snapshot. For example, in this example, directory 514 is associated with snapshot 2 because for this example, it was modified or created after snapshot 1 was generated (during epoch 2) and has remained unmodified since then. Accordingly, by observation, a modification to file object 524 caused it to be associated with snapshot 2 which forced its parent, directory 514 to also be associated with snapshot 2. In other words, for some embodiments, if a file system object is modified in a current epoch, it will be associated with the next snapshot that closes or ends the current epoch.

Compare, for example, in some embodiments, how directory 510 is associated with snapshot 1 and all of its children are also associated with snapshot 1. This indicates that directory 510 and its children were created during epoch 1 before the first snapshot (snapshot 1) was generated and that they have remained unmodified subsequent to snapshot 1.

In one or more of the various embodiments, if file system 500 is being replicated, a replication engine, such as, replication engine 324, may be arranged to employ the snapshot or epoch information of the file system objects in a file system to determine which file system objects should be copied to one or more target file systems.

In one or more of the various embodiments, replication engines may be arranged to track the last snapshot associated with the last replication job for a file system. For example, in some embodiments, a replication engine may be arranged to trigger the generation of a new snapshot prior to starting a replication jobs. Also, in some embodiments, a replication engine may be arranged perform replication jobs based on existing snapshots. For example, in some embodiments, a replication engine may be configured to launch a replication jobs every other snapshot, with the rules for generating snapshots being independent from the replication engine. Generally, in one or more of the various embodiments, replication engines may be arranged to execute one or more rules that define whether the replication engine should trigger a new snapshot for each replication job or use existing snapshots. In some embodiments, such rules may be provided by snapshot policies, configuration files, user-input, built-in defaults, or the like, or combination thereof.

In one or more of the various embodiments, file system engines, such as, file system engine 322 may be arranged to update parent object meta-data (e.g., current update epoch or snapshot number) before a write operation is committed or otherwise consider stable. For example, if file object 520 is updated, the file system engine may be arranged to examine the epoch/snapshot information for directory 510, directory 506, and directory 504 before committing the update to file object 520. Accordingly, in this example, if file object 520 is updated, directory 510, directory 506 and directory 508 may be associated the current epoch (5) before the write to file object 520 is committed (which will also associated file object 520 with epoch 5) since the update is occurring during the current epoch (epoch 5).

FIG. 6 illustrates a logical represent of two file systems arranged for managing cluster to cluster replication for distributed file systems in accordance with one or more of the various embodiments. In this example, file system 600 may be considered the source file system. In this example, file system 600 starts at root 602 and includes various file system objects, including, directory 604, directory 606, directory 608, file object 610, file object 612, file object 614, and so on. Likewise, for this example, file system 616 may be considered the target file system. In this example, file system 616 starts at root 618 and includes various file system objects, including, directory 620, directory 622, directory 624, file object 626, file object 628, file object 630, and so on.

Similar to FIG. 5, circles in FIG. 6 represent directory objects (file system objects that have children) and rectangles in FIG. 6 represent file system objects that are files, documents, blocks, or the like. The latest snapshot number for each file system object is indicated by the number in the center of each file system object. For example, directory object 606 is associated with snapshot number 5.

In one or more of the various embodiments, if a replication engine initiates a replication job, that job may be associated with a determined snapshot. In some embodiments, a replication engine may be arranged to trigger the generation of a snapshot before starting a replication job. In other embodiments, the replication engine may base a replication job on a snapshot that already exists. In this example, the replication engine may be arranged to initiate a replication job for the highest snapshot in file system 600, snapshot 5.

Accordingly, in one or more of the various embodiments, the replication engine may traverse file system 600 to identify file system objects that need to be copied to file system 616. In this example, as shown in the meta-data (meta-data 632) for file system 600, the current epoch for file system 600 is epoch 6 and the latest snapshot is snapshot 5. In some embodiments, the replication engine may be arranged to find the file system objects that have changed since the last replication job. In this example, meta-data 634 for file system 616 shows that the current epoch for file system 616 is epoch 5 and the latest snapshot for file system 616 is snapshot 4.

Note, in one or more of the various embodiments, the meta-data 632 or meta-data 634 may be stored such that they are accessible from either file system 600 or file system 616. Likewise, in some embodiments, one or more file systems may be provided meta-data information from another file system. In some embodiments, file systems may be arranged to communicate meta-data information, such as, meta-data 632 or meta-data 634 to another file system. In some embodiments, source file systems may be arranged to maintain a local copy of meta-data for the one or more target file systems. For example, in some embodiments, the source cluster may store the target cluster's Current Epoch/Highest Snapshot values.

In one or more of the various embodiments, file system 600 and file system 616 may be considered synced for replication. In some embodiments, configuring a replication target file system may include configuring the file system engine that manages the target file system to stay in-sync with the source file system. In some embodiments, staying in-sync may include configuring the target file system to be read-only except for replication activity. This enables snapshots on the target file system to mirror the snapshots on the source file system. For example, if independent writes were allowed on the target file system, the snapshots on the target file system may cover different file system objects than the same numbered snapshots on the source file system. This would break the replication process unless additional actions are taken to sync up the target file systems with the source file system.

In this example, a replication engine is configured to replicate file system 600 on file system 616. For this example, it can also be assumed that snapshot 5 of file system 600 is the latest snapshot that the replication engine is configured to replicate.

Accordingly, in this example, in one or more of the various embodiments, the replication engine may be arranged to determine the file system objects in file system 600 that need to be replicated on file system 616. So, in this case, where file system 616 has been synced to snapshot 4 of file system 600, the replication engine may be arranged to identify the file system objects on file system 600 that are associated with snapshot 5. The file system objects associated with snapshot 5 on file system 600 are the file system objects that need to be replicated on file system 616.

In one or more of the various embodiments, the replication engine may be arranged to compare the snapshot numbers associated with a file system object with the snapshot number of the snapshot that is being replicated to the target file system. Further, in one or more of the various embodiments, the replication engine may begin this comparison at the root of the source file system, root 602 in this example.

In one or more of the various embodiments, if the comparison discovers or identifies file system objects that have been modified since the previous replication job, those file system objects are the ones that need to be copied to the target file system. Such objects may be described as being in the replication snapshot. This means that that the file system object has changes that occurred during the lifetime of the snapshot the replication job is based on—the replication snapshot. If a directory object is determined to be in the replication snapshot, the replication engine may be arranged to descend into that object to identify the file system objects in that directory object that may need to be replicated. In contrast, if the replication engine encounters a directory object that is not in the replication snapshot, the replication engine does not have to descend into the that directory. This optimization leverages the guarantee that the snapshot value of a parent object is the same as the highest (or newest) snapshot that is associated with one or more of its children objects.

In one or more of the various embodiments, if the replication engine identifies file system objects in the source file system that may be eligible for replication, the contents of those file system objects may be copied to target file system. In one or more of the various embodiments, writing the data associated with the identified file system objects to the target file systems also includes updating the snapshot information and current epoch of the target file system.

In this example, file system 600 is being replicated to file system 616. FIG. 6 shows how file system 616 appears before the replication has completed. At the completion of the replication job, file system 616 will appear the same as file system 600, including an update to meta-data 634 that will record the current epoch for file system 616 as epoch 6 and set the highest snapshot to snapshot 5.

In this example, the file system objects that a replication engine would identify for replication include directory 604, directory 606, and file object 612 as these are the only objects in file system 600 that are associated with snapshot 5 of file system 600. In one or more of the various embodiments, after these file system object are copied to file system 616, file system 616 will look the same as file system 600. Accordingly, in this example: directory 620 will be associated with snapshot 5 (for file system 616); directory 622 will be associated with snapshot 5; and file object 628 will be modified to include the content of file object 612 and will be associated with snapshot 5.

In one or more of the various embodiments, after the replication engine has written the changes associated with the replication job to the one or more target file systems, it may be arranged to trigger the generation of a snapshot to capture the changes made by the replication job.

In summary, in one or more of the various embodiments, a replication job may start with a snapshot, the replication snapshot, on the source file system. One or more file system objects on the source file system are determined based on the replication snapshot. The determined file system objects may then be copied and written to the target file system. After all the determined file system objects are written to the target file system, a snapshot is taken on the target file system to preserve the association of the written file system objects to target file system replication snapshot. Note, in one or more embodiments, there may be variations of the above. For example, a target file system may be configured close the target file systems current update epoch before a new replication job starts rather than doing at the completion of a replication job. For example, the target file system may be at current update epoch 4, when a new replication job starts, one of the replication engines first actions may be to trigger a snapshot on the target file system. In this example, that would generate snapshot 4 and set the current update epoch to epoch 5 on the target file system. Then in this example, the file system objects associated with the pending replication job will be modified on the target file system during epoch 5 of the target file system, which will result in them being associated with snapshot 5 when it is generated.

In one or more of the various embodiments, keeping the current epoch of the source file system and the target file system the same value may be not be a requirement. It this example, it is described as such for clarity and brevity. However, in one or more of the various embodiments, a source file system and a target file system may be configured to maintain distinct and different values for current epoch and highest snapshot even though the content of the file system objects may be the same. For example, a source file system may have been active much longer than the target file system. Accordingly, for example, a source file system may have a current epoch of 1005 while the target file system has a current epoch of 5. In this example, the epoch 1001 of the source file system may correspond to epoch 1 of the target file system. Likewise, for example, if the target file system has a current epoch of 1005 and the source target file system has a current epoch of 6, at the end of a replication job, the target file system will have a current epoch of 1006.

In one or more of the various embodiments, traversing the portion of file system starting from a designated root object and skipping the one or more parent objects that are unassociated with the replication snapshot improves efficiency and performance of the network computer or its one or more processors by reducing consumption of computing resources to perform the traversal. This increased performance and efficiency is realized because the replication engine or file system engine is not required to visit each object in the file store to determine if it has changed or otherwise is eligible for replication. Likewise, in some embodiments, increased performance and efficiency may be realized because the need for additional object level change tracking is eliminated. For example, an alternative conventional implementation may include maintaining a table of objects that have been changed since the last the replication job. However, for large file systems, the size of such a table may grow to consume a disadvantageous amount of memory.

In one or more of the various embodiments, as described above, replication engines may be arranged to designate or generate a snapshot as a replication snapshot. In some embodiments, replication snapshots on source file systems may be snapshots that represent the file system objects that need to be copied to from a source file system to a target file system. And, in some embodiments, replication snapshots on target file system may be associated with the file system objects copied from a source file system as part of a completed replication job.

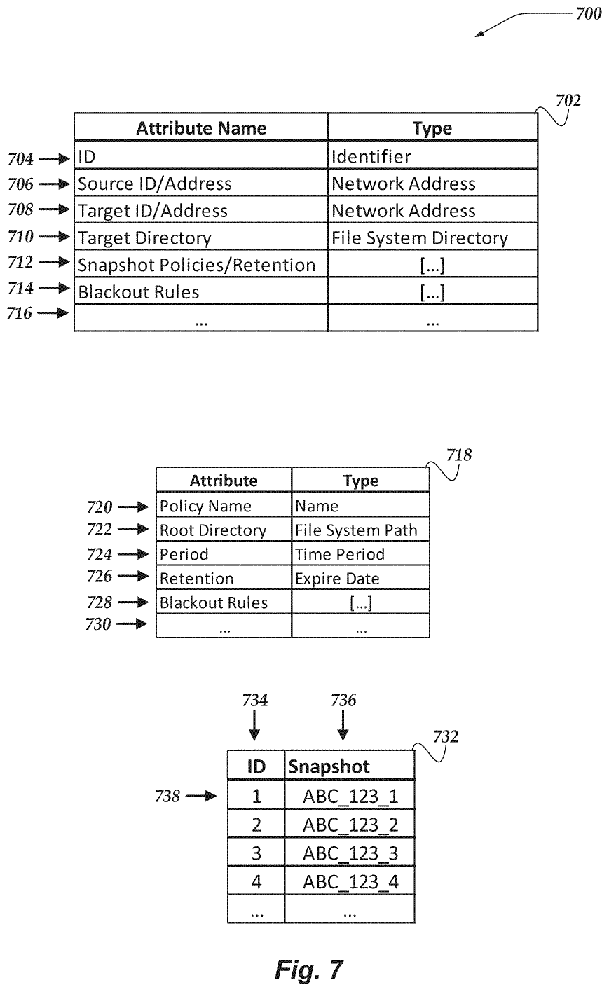

FIG. 7 illustrates of logical schematic of a portion of data structures 700 for managing cluster to cluster replication for distributed file systems in accordance with one or more of the various embodiments. In one or more of the various embodiments, replication engines may be arranged to generate or maintain one or more data structures for managing replication relationships, snapshot policies, snapshots, or the like.

In one or more of the various embodiments, replication relationships may be arranged to include various attributes for defining or enforcing replication relationships. In this example, table definition 702 may describe data structures for replication relationships. Accordingly, table definition 702 may include various attributes, including: identifier attribute 702 for storing an identifier of a given replication relationship; source ID/address attribute 704 for storing a network address (or other identifier) of the source file system; target ID/address attribute 708 for storing a network address (or other identifier) of the target file system; target directory attribute 710 for storing a location in the target file system where replicated data or snapshots may be stored on the target file system; snapshot policies/retention attribute 712 for storing or referencing a collection of snapshot policies and remote retention periods that may be associated with a replication relationship; blackout rules attribute 714 for storing blackout rules, or the like; additional attributes 716 for storing one or more other attributes that may be associated with replication relationships.

In one or more of the various embodiments, snapshot policies may be arranged to include various attributes for defining or enforcing snapshot policies. In this example, table definition 718 may describe data structures for snapshot policies. Accordingly, table definition 718 may include various attributes, including: name attribute 720 for storing a name or label of a given snapshot policy; root directory attribute 722 for storing a location in the source file system that may be considered the root directory for a snapshot; period attribute 724 for storing rules associated with when or how often a snapshot may be generated; retention attribute 726 for storing local retention rules including a local retention period for a snapshot; blackout rules attribute 728 for storing blackout rules for a snapshot; additional attributes 730 for one or more other attributes that may be associated with snapshots.

In one or more of the various embodiments, replication relationship may be arranged to be associated with a snapshot queue for maintaining an ordered list of snapshots that need to copied to a target file system. In this example, table 732 has two attributes, ID attribute 734 for storing identifiers associated with snapshots in the queued, and snapshot attribute 736 for storing name or label associated with a snapshot. Also, in this example, record 738 represents a snapshot in the first position of queue 732. Accordingly, in some embodiments, the snapshot represented by record 738 may be copied to a target file system before the other snapshots in the queue.

### Generalized Operations

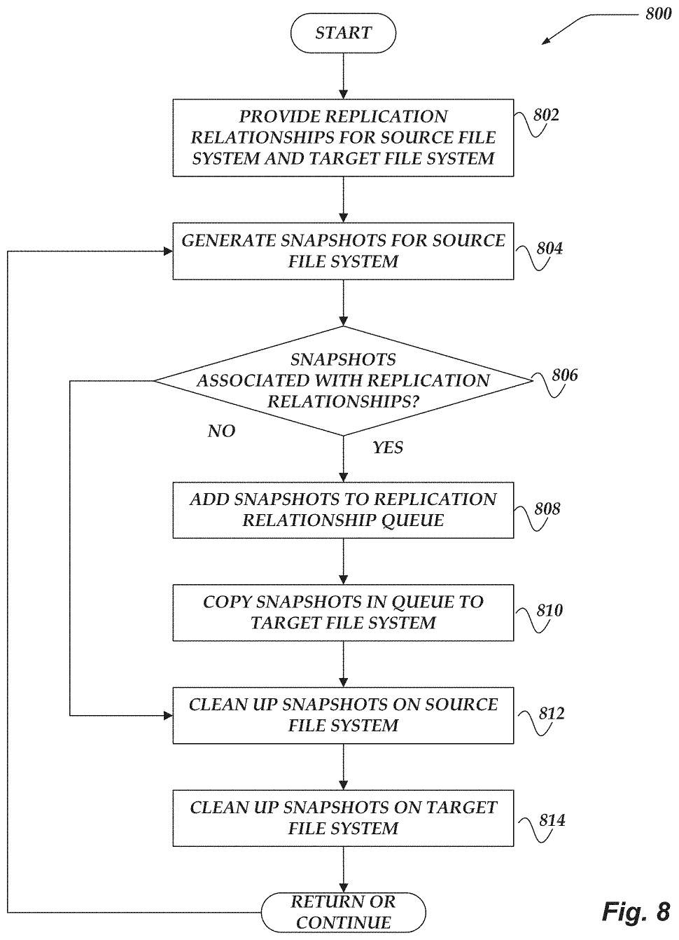

FIGS. 8-11 represent generalized operations for managing cluster to cluster replication for distributed file systems in accordance with one or more of the various embodiments. In one or more of the various embodiments, processes 800, 900, 1000, and 1100 described in conjunction with FIGS. 8-11 may be implemented by or executed by one or more processors on a single network computer, such as network computer 300 of FIG. 3. In other embodiments, these processes, or portions thereof, may be implemented by or executed on a plurality of network computers, such as network computer 300 of FIG. 3. In yet other embodiments, these processes, or portions thereof, may be implemented by or executed on one or more virtualized computers, such as, those in a cloud-based environment. However, embodiments are not so limited and various combinations of network computers, client computers, or the like may be utilized. Further, in one or more of the various embodiments, the processes described in conjunction with FIGS. 8-11 may perform actions for managing cluster to cluster replication for distributed file systems in accordance with at least one of the various embodiments or architectures such as those described in conjunction with FIGS. 4-7. Further, in one or more of the various embodiments, some or all of the actions performed by processes 800, 900, 1000, and 1100 may be executed in part by file system engine 322, or replication engine 324.

FIG. 8 illustrates an overview flowchart for process 800 for managing cluster to cluster replication for distributed file systems in accordance with one or more of the various embodiments. After a start block, at block 802, in one or more of the various embodiments, replication engines may be arranged to provide one or more replication relationships that each associate a source file system and a target file system. In one or more of the various embodiments, replication engines or file system engines may be arranged to provide user interfaces that enable users to create one or more replication relationships the define the various parameters associated with replicating data or file system objects in a source file system onto a target file system.

In some embodiments, replication engines may be arranged to automatically generate one or more replication relationships based on other configuration information. For example, in some embodiments, file system engines may provide user interfaces that may enable users to create mirroring rules, archiving rules, various high-availability configurations, or the like, that may result in the automatic creation of one or more replication relationships.

At block 804, in one or more of the various embodiments, replication engines may be arranged to generate one or more snapshots for the source file system. In one or more of the various embodiments, file systems may be arranged to have one or more snapshot policies that replication engines may employ to generate a variety of different snapshots that preserve point-in-time state of one or more portions the file system. In one or more of the various embodiments, snapshot policies may define rules that may determine if a snapshot may be generated.

At decision block 806, in one or more of the various embodiments, if one or more of the generated snapshots may be associated with one or more replication relationships, control may flow to block 808; otherwise, control may flow to block 812.

In one or more of the various embodiments, replication engines may be arranged to generate snapshots for various defined snapshot policies, some of which may be associated with replication relationships.

At block 808, in one or more of the various embodiments, replication engines may be arranged to add one or more snapshots to a replication relationship queue. In one or more of the various embodiments, if a snapshot may be generated under a snapshot policy associated with one or more replication relationships, those snapshots may be added to replication relationship queues associated with the respective replication relationships.

At block 810, in one or more of the various embodiments, replication engines may be arranged to copy the snapshots in replication relationship queues to target file systems associated with the source file system. In one or more of the various embodiments, replication engines may be arranged copy snapshots included in replication relationship queues to target file systems. In some embodiments, replication engines may be arranged to copy queued snapshots such that the point-in-time snapshot data may be preserved. Also, in one or more of the various embodiments, replication engines may be arranged to preserve the structure or format of the snapshots as well as the data represented by the snapshots.

In one or more of the various embodiments, replication engines may be arranged to support various snapshot formats or snapshot techniques, including snapshots described for FIG. 5, FIG. 6, or the like. However, one of ordinary skill in the art will appreciate that other snapshot formats, including tar files, or the like, may be employed without departing from the scope of these innovations. Accordingly, replication engines may be arranged to employ rules or instructions provided via configuration information to determine how to copy snapshots having various formats.

At block 812, in one or more of the various embodiments, replication engines may be arranged to cleanup one or more snapshots that may be on the source file system. In one or more of the various embodiments, snapshot policies may be associated with retention rules that may be enforced by replication engines. Accordingly, in some embodiments, if retention rules associated with snapshots indicate that they may be eligible to be deleted, the replication engines may delete or otherwise discard the snapshots that may be eligible for removal.

In one or more of the various embodiments, if one or more snapshots may be in one or more replication relationship queues associated with the source file system, normal retention rules may be suspended until the one or more snapshots may be removed from the one or more replication relationship queues.

At block 814, in one or more of the various embodiments, replication engines may be arranged to cleanup one or more snapshots that may be on the target file system. As described above, snapshots copied to target file systems based on replication relationships may be associated with a remote retention period that defines how replicated snapshots may be stored on target file systems before being deleted from the target file systems.

Accordingly, in one or more of the various embodiments, if one or more replication snapshots on target file systems have expired remote retention periods, those one or more replication snapshots may be deleted from the target file system. Note, in some embodiments, replication engines associated with the target file system may be arranged to cleanup replicated snapshots that may have expired.

Next, in one or more of the various embodiments, control may be returned to a calling process or control may loop back to block 804 unless process 800 may be paused or terminated.

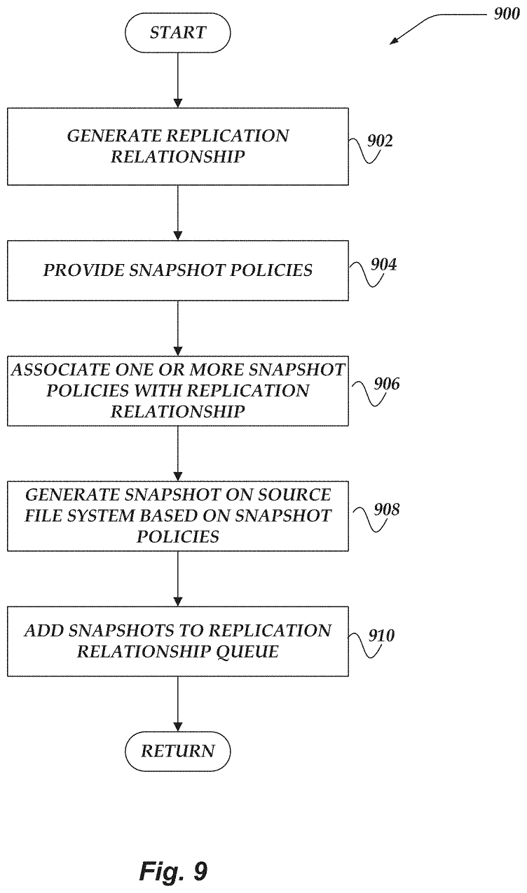

FIG. 9 illustrates a flowchart for process 900 for managing cluster to cluster replication for distributed file systems in accordance with one or more of the various embodiments. After a start block, at block 902, in one or more of the various embodiments, replication engines may be arranged to generate a replication relationship that associates a source file system and a target file system. As described above, replication relationships may be instances of data structures that include one or more parameter values that define one or more of the characteristics for replicating data or snapshots from source file systems to target file systems.

In one or more of the various embodiments, replication relationship parameters may include: a network address or identifier of the target file system; a directory in the source file system that is the root directory of the replication relationship; a root directory in the target file system; blackout periods; or the like.

Also, in some embodiments, replication relationships may define if continuous replication of the source file system should be performed as well.

At block 904, in one or more of the various embodiments, replication engines may be arranged to provide one or more snapshot policies. In one or more of the various embodiments, file systems may be configured to support one or more snapshot policies that define parameters associated with taking point-in-time snapshots of one or more portions of the source file system. In some embodiments, as described above, snapshot policy parameters may include source file system root directory, snapshot identifiers, labels/descriptions, blackout windows, local retention rules, or the like. In some embodiments, local retention rules may define local retention periods for snapshots generated under a given snapshot policy.

In one or more of the various embodiments, one or more snapshot policies may be defined independently from replication relationships. Accordingly, in one or more of the various embodiments, these one or more snapshot policies may be displayed to authorized users, enabling them to select one or more of them to associated with replication relationships. Also, in one or more of the various embodiments, snapshot policies may be added to replication relationships if they are created.

At block 906, in one or more of the various embodiments, replication engines may be arranged to associate one or more of the snapshot policies with the replication relationships. As described above, one or more snapshot policies may be associated with one or more replication relationships. In one or more of the various embodiments, each snapshot policy may be associated with a remote retention period that may define how long snapshots generated by the snapshot policy may be preserved on the target file system.

At block 908, in one or more of the various embodiments, replication engines may be arranged to generate one or more snapshots based on the one or more snapshot policies. As described above, in some embodiments, snapshot policies may be employed by replication engines to generate one or more snapshots according to parameters defined by snapshot policies.

At block 910, in one or more of the various embodiments, replication engines may be arranged to add the one or more snapshots to a queue associated with the one or more replication relationships it may be associated with. In one or more of the various embodiments, snapshots generated based on snapshot policies associated with replication relationships may be added the replication relationship queues that correspond to the replication relationships associated with the snapshot policies that the snapshots were created under.

In one or more of the various embodiments, replication engines may be arranged to associate a read-only lock with snapshots that may be in one or more replication relationship queues. Thus, in some embodiments, if snapshots may be in a replication relationship queue, they may be preserved at least until they are removed from the one or more replication relationship queue they may be associated with.

Next, in one or more of the various embodiments, control may be returned to a calling process.

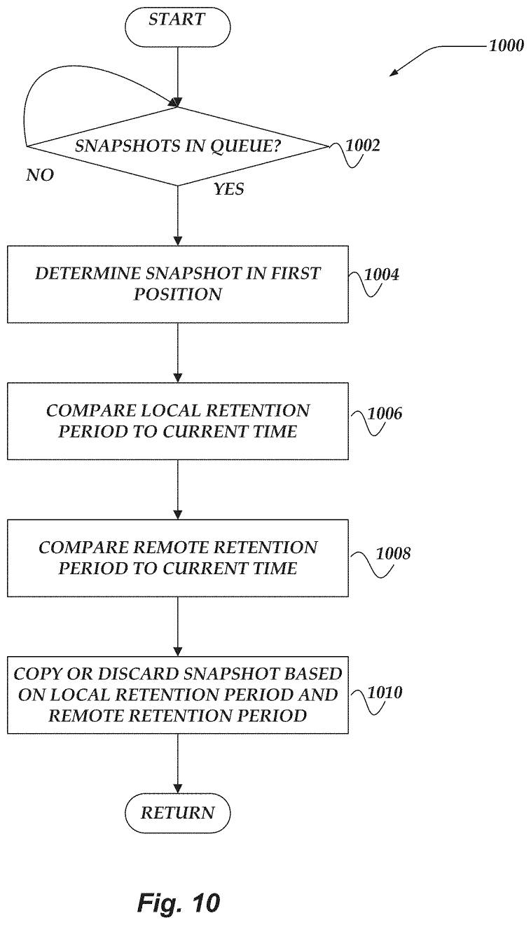

FIG. 10 illustrates a flowchart for process 1000 for managing cluster to cluster replication for distributed file systems in accordance with one or more of the various embodiments. After a start block, at decision block 1002, in one or more of the various embodiments, if a queue associated with a replication relationship includes one or more snapshots, control may flow to block 1004; otherwise, control may loop back to decision block 1002. In one or more of the various embodiments, replication engines may be arranged to monitor each replication relationship queue associated with replication relationships that may be operative on a file system. Accordingly, in some embodiments, as snapshots are generated under snapshot policies associated with replication relationships, they may be added to the replication relationship queues of the replication relationships that may be associated with the snapshot policies. In some embodiments, replication engines may be arranged to detect if snapshots may be added to replication relationship queues.

In some embodiments, queue engines or queue services employed by replication engines for queuing snapshots may be arranged to provide notifications or alerts to replication engines if snapshots may be added to replication relationship queues.

At block 1004, in one or more of the various embodiments, replication engines may be arranged to determine a snapshot that may be in the first position of the queue. In one or more of the various embodiments, in some cases, more than one snapshot generated by one or more snapshot policies may be in the same replication relationship queue at the same time. Accordingly, in one or more of the various embodiments, a snapshot determined to be in the first of the queue may be selected for consideration to be copied to the target file system.

At block 1006, in one or more of the various embodiments, replication engines may be arranged to compare the local retention period associated with the snapshot to the current time. In one or more of the various embodiments, snapshot policies may define local retention policies that include a local retention period. In some embodiments, local retention periods define how long a snapshot may be preserved on the source file system. However, in some embodiments, if a snapshot may be in a replication relationship queue and its local retention period has expired, replication engines may be arranged to defer deleting the snapshot and its associated data. Otherwise, in some embodiments, replication engines may be arranged to automatically delete snapshots and their data if their local retention period has expired.

At block 1008, in one or more of the various embodiments, replication engines may be arranged to compare the remote retention period associated with the snapshot to the current time. As described above, replication relationships may be arranged to include remote retention rules that may be define remote retention periods for snapshot policies. Thus, in some embodiments, snapshots in replication relationship queues may be associated with remote retention periods based on the remote retention rules defined by the replication relationships they may be associated with.

In one or more of the various embodiments, remote retention periods may be longer than local retention periods. For example, in some embodiments, replication relationships may associate snapshot policies with remote retention periods that are longer than local retention periods to enable one or more point-in-time snapshots to be archived for longer periods of time on lower cost storage systems rather than disadvantageously archiving snapshots on costly high performance storage systems.

In one or more of the various embodiments, one or more snapshots in one or more replication relationship queues may have been waiting to being copied to target file systems for so long that their remote retention periods have expired while the one or more snapshots may be waiting in the replication relationship queues.

At block 1010, in one or more of the various embodiments, replication engines may be arranged to copy or discard snapshots based on the local retention period or the remote retention period.

In one or more of the various embodiments, if the local retention period for a snapshot in a replication relationship queue has expired and its remote retention period remains unexpired, replication engines may be arranged to defer the normally scheduled local deletion of the snapshot until the snapshot and its data have been copied to the target file system in accordance with the relevant replication relationship. For example, in one or more of the various embodiments, replication engines may be arranged to apply a read-only lock, or the like, to snapshots that remain in replication relationship queues waiting to be copied to target file systems. In this example, for some embodiments, replication engines may be arranged to lift the read-only lock, enabling normal or regular cleanup processes to delete the snapshot and its data from the source file system.

In one or more of the various embodiments, if the remote retention period and the local retention period of a snapshot in the replication relationship queue are both expired, the replication engines may be arranged to remove the snapshot from the replication relationship queue before copying it to the target file system. Thus, in some embodiments, snapshots associated with both an expired local retention period and an expired remote retention period may be discarded or otherwise deleted.

In one or more of the various embodiments, if the remote retention period of a snapshot has expired but its local retention period remains unexpired, the replication engines may remove the snapshot from the replication relationship queue. Further, in some embodiments, if the snapshot is associated with a read-only lock associated with a replication relationship queue, the replication engines may remove the lock from the snapshot.

Note, in some embodiments, replication engines may be configured to prevent replication relationships from having remote retention periods that may be shorter than local retention periods. However, in some cases, organizations may want to copy one or more snapshots to target file systems and then have them automatically deleted from the target file systems after a certain time even though the one or more snapshots may remain on the source file system because of the longer local retention periods. For example, for some embodiments, a replication relationship may be configured to copy some snapshots to a target file system where they are to remain for 24 hours before automatically being deleted even though the local retention period on the source file system may be 1 year.

In some embodiments, replication engines may be arranged to employ a monitoring process or watchdog service that automatically monitors retention periods of queued snapshots to automatically identify snapshots that may be removed from replication relationship queues or otherwise discarded. Alternatively, in one or more of the various embodiments, replication engines may be arranged to evaluate local retention periods and remote retention periods before starting a snapshot copy job.

Next, in one or more of the various embodiments, control may be returned to a calling process.

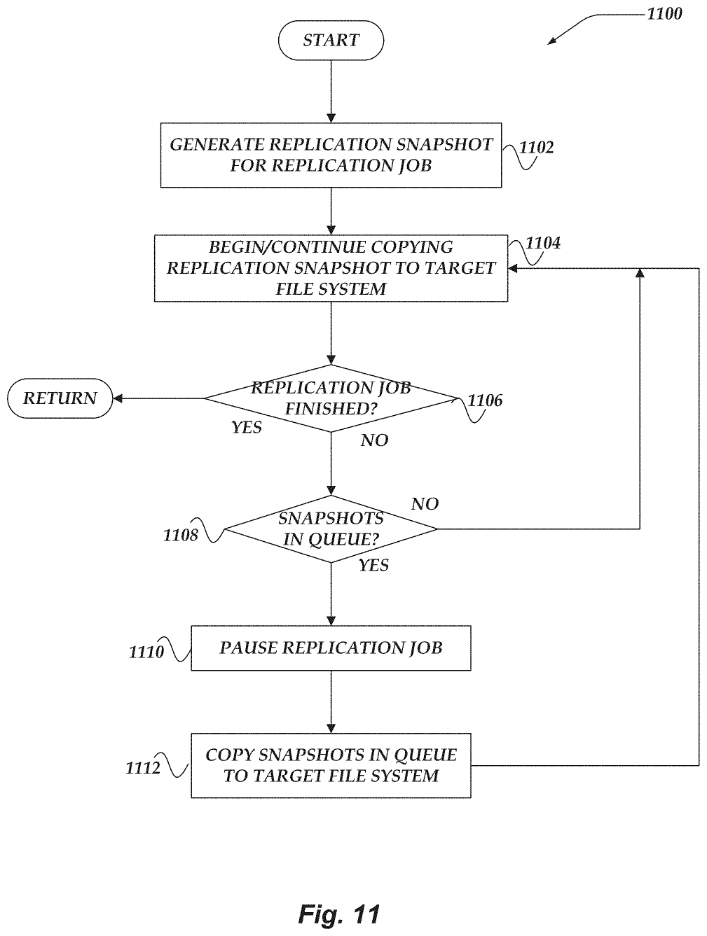

FIG. 11 illustrates a flowchart for process 1100 for managing cluster to cluster replication for distributed file systems in accordance with one or more of the various embodiments. After a start block, at block 1102, in one or more of the various embodiments, replication engines may be arranged to generate a replication snapshot for a replication job.

In one or more of the various embodiments, replication engines may be arranged to enable continuous replication of one or more portions of a source file system to a target file system. Accordingly, in one or more of the various embodiments, replication relationships may be configured to enable snapshot replication and continuous replication.

As described above, in some embodiments, if continuous replication may be enabled, replication engines may be arranged to automatically generate replication snapshots that may be employed to determine a current version of the data stored on one or more portions of the source file system. In some embodiments, replication engines may be arranged initiate replication jobs that replicate the determined changes on target file systems based on the replication snapshot made on the source file system. In some embodiments, as replication jobs may be completed, corresponding replication snapshots on the source file system may be automatically deleted.

Accordingly, in one or more of the various embodiments, replication relationships may be selectively defined to activate continuous replication. Also, in some embodiments, replication relationships may be employed to define various continuous replication parameters, such as, replication period, replication root directory, replication target root directory, or the like. Note, in some embodiments, retention periods for replication snapshots may not be required because, in some embodiments, replication engines may be arranged to automatically delete replication snapshots at the completion of their corresponding replication jobs.

At block 1104, in one or more of the various embodiments, replication engines may be arranged to begin or continue copying a replication snapshot that may be associated with the replication job to the target file system. In one or more of the various embodiments, if a replication snapshot is available, a replication job may begin traversing the source file system using the replication snapshot to determine file system changes (e.g., changes associated file system objects) that need to be replicated on the target file system.

In many cases, replication jobs may be completed relatively quickly depending on the source file system or the continuous replication period. For example, in some embodiments, a replication relationship may define a continuous replication period to be 10 seconds, 1 minute, 10 minutes, or the like. Accordingly, in some embodiments, short continuous replication periods may involve less data changes than longer continuous replication periods. Likewise, in some embodiments, a very write active source file system that receives many writes may result in replication job that may take longer to complete because more data may need to be copied to the target file system than for less active file systems.

Further, in one or more of the various embodiments, one or more utilization metrics of the source file system, target file system, network congestion, or the like, may impact how long it takes a replication engine to complete replication jobs. In some embodiments, replication engines may be arranged to throttle or otherwise rate limit replication jobs depending on the current performance conditions of the source file system, target file system, network environments, or the like.

In one or more of the various embodiments, replication jobs may be paused, slowed, or deferred for various reasons. Accordingly, in one or more of the various embodiments, if unfinished an replication job may be paused, replication engines may be arranged to restart the replication jobs.

At decision block 1106, in one or more of the various embodiments, if the replication job may be complete, control may be returned to a calling process; otherwise, control may flow to decision block 1108. In some embodiments, replication jobs may be considered complete if they have copied all the changes associated with their correspond replication snapshot to the target file system. In some embodiments, a replication job may be canceled or otherwise terminated by authorized users.

At decision block 1108, in one or more of the various embodiments, if there may be snapshots in the replication relationship queue, control may flow to block 1110; otherwise, control may loop back to block 1104.

In one or more of the various embodiments, replication engines may be arranged to run continuous replication jobs independently from other snapshot policies that may be defined for the source file system. Accordingly, in one or more of the various embodiments, replication relationships configured for continuous replication may also be associated with one or more snapshot policies that may be generating a variety of snapshots that may be added to replication relationship snapshot queues.

Accordingly, in one or more of the various embodiments, replication engines may be arranged to monitor replication relationship queues to determine if one or more snapshots may be added. Likewise, in some embodiments, one or more watchdog services, or the like, may be arranged to monitor replication relationship queues and notify replication engines if snapshots may be added the replication relationship queues.

At block 1110, in one or more of the various embodiments, replication engines may be arranged to pause the replication job. In one or more of the various embodiments, replication engines may be arranged to prioritize snapshot replication over continuous replication. Accordingly, in one or more of the various embodiments, pending replication jobs may be paused or otherwise temporarily halted.

In one or more of the various embodiments, replication snapshots associated with paused replication job may remain preserved. Likewise, in some embodiments, changes on target file systems that may be associated partially completed replication jobs may be preserved in their current partially complete state.

At block 1112, in one or more of the various embodiments, replication engines may be arranged to copy one or more snapshots in replication relationship queues from the source file system to the target file system. As described above, replication engines may be arranged to copy snapshots in replication relationship queues to their designated target file systems.

In one or more of the various embodiments, if the replication relationship queue is emptied of snapshots, replication engines may be arranged to continue processing unfinished replication jobs.

Next, in one or more of the various embodiments, control may be returned to a calling process.

It will be understood that each block in each flowchart illustration, and combinations of blocks in each flowchart illustration, can be implemented by computer program instructions. These program instructions may be provided to a processor to produce a machine, such that the instructions, which execute on the processor, create means for implementing the actions specified in each flowchart block or blocks. The computer program instructions may be executed by a processor to cause a series of operational steps to be performed by the processor to produce a computer-implemented process such that the instructions, which execute on the processor, provide steps for implementing the actions specified in each flowchart block or blocks. The computer program instructions may also cause at least some of the operational steps shown in the blocks of each flowchart to be performed in parallel. Moreover, some of the steps may also be performed across more than one processor, such as might arise in a multi-processor computer system. In addition, one or more blocks or combinations of blocks in each flowchart illustration may also be performed concurrently with other blocks or combinations of blocks, or even in a different sequence than illustrated without departing from the scope or spirit of the invention.

Accordingly, each block in each flowchart illustration supports combinations of means for performing the specified actions, combinations of steps for performing the specified actions and program instruction means for performing the specified actions. It will also be understood that each block in each flowchart illustration, and combinations of blocks in each flowchart illustration, can be implemented by special purpose hardware based systems, which perform the specified actions or steps, or combinations of special purpose hardware and computer instructions. The foregoing example should not be construed as limiting or exhaustive, but rather, an illustrative use case to show an implementation of at least one of the various embodiments of the invention.

Further, in one or more embodiments (not shown in the figures), the logic in the illustrative flowcharts may be executed using an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. In one or more embodiments, a microcontroller may be arranged to directly execute its own embedded logic to perform actions and access its own internal memory and its own external Input and Output Interfaces (e.g., hardware pins or wireless transceivers) to perform actions, such as System On a Chip (SOC), or the like.

1. A method for managing data in a file system over a network using one or more processors that execute instructions to perform actions, comprising:
providing a source file system and a target file system that are associated based on a replication relationship, wherein the replication relationship is associated with one or more snapshot policies that are user selectable, and wherein the replication relationship includes three or more different categories of parameters, including snapshot policy parameters, snapshot relationship parameters, and replication parameters, and wherein one or more snapshot policy parameters comprise one or more of a source file system root directory, a snapshot identifier, a blackout window, or a local retention rule, and wherein one or more snapshot relationship parameters comprise one or more of a network address, an identifier of the target file system, a directory in the source file system that is the root directory of the replication relationship, a root directory in the target file system or a blackout period, and wherein one or more replication parameters comprise one or more of a replication period, a replication root directory, or a replication target root directory;
generating one or more snapshots on the source file system based on the one or more snapshot policies, wherein each snapshot is a point-in-time archive of a state of a same portion of the source file system;
adding the one or more snapshots to a queue on the source file system that is associated with the replication relationship, wherein the snapshot is associated with a snapshot retention period that is local to the source file system, wherein the local snapshot retention period is provided by a corresponding snapshot policy that is local to the source file system and a remote replication retention period based on the replication relationship, wherein each snapshot in the queue is ordered based on a time of creation of each snapshot on the source file system, and wherein each snapshot in one or more replication relationship queues is associated with a read only lock until removed from the one or more replication relationship queues; and
determining a snapshot that is in a first position in the queue based on the time of creation, wherein further actions are performed for the determined snapshot, including:
in response to the local snapshot retention period being unexpired and the remote replication retention period being unexpired, copying the snapshot to the target file system;
in response to the local snapshot retention period being expired and the remote replication retention period being unexpired, copying the snapshot to the target file system; and
in response to the local snapshot retention period being expired and the remote replication retention period being expired, discarding the snapshot.

2. The method of claim 1, further comprising:
generating a replication snapshot on the source file system that is separate from the one or more snapshots;
executing a replication job to copy the replication snapshot from the source file system to the target file system; and
in response to the one or more snapshots being in the queue, performing further actions, including:
pausing the execution of the replication job;
copying the one or more snapshots to the target file system; and
unpausing the execution of the replication job.

3. The method of claim 1, wherein copying the snapshot to the target file system, further comprises:
in response to an error condition that interferes with the copying of the snapshot to the target file system, performing further actions, including:
pausing the copying of the snapshot to the target file system; and
resuming the copying of the snapshot to the target file system, wherein one or more portions of the snapshot that are on the target file system are omitted from copying.

4. The method of claim 1, further comprising:
providing one or more other replication relationships on the source file system, wherein each other replication relationship is associated with a dedicated queue that is separate from the queue; and
associating the one or more snapshot policies with each other replication relationship, wherein one or more different remote retention periods are provided by the one or more other replication relationships.

5. The method of claim 1, further comprising:
providing one or more source storage systems for the source file system; and
providing one or more target storage systems for the target file system, wherein the one or more source storage systems are associated with higher performance and higher cost than the target storage systems.

6. The method of claim 1, further comprising, providing one or more blackout periods that are associated with the replication relationship, wherein copying the one or more snapshots in the queue are paused during the one or more blackout periods.

7. The method of claim 1, wherein performing the further actions for the determined snapshot, further comprises, in response to the local snapshot retention period being unexpired and the remote replication retention period being expired, removing the snapshot from the queue.

8. A network computer for managing data in a file system, comprising:
a memory that stores at least instructions; and
one or more processors that execute instructions that perform actions, including:
providing a source file system and a target file system that are associated based on a replication relationship, wherein the replication relationship is associated with one or more snapshot policies that are user selectable, and wherein the replication relationship includes three or more different categories of parameters, including snapshot policy parameters, snapshot relationship parameters, and replication parameters, and wherein one or more snapshot policy parameters comprise one or more of a source file system root directory, a snapshot identifier, a blackout window, or a local retention rule, and wherein one or more snapshot relationship parameters comprise one or more of a network address, an identifier of the target file system, a directory in the source file system that is the root directory of the replication relationship, a root directory in the target file system or a blackout period, and wherein one or more replication parameters comprise one or more of a replication period, a replication root directory, or a replication target root directory;
generating one or more snapshots on the source file system based on the one or more snapshot policies, wherein each snapshot is a point-in-time archive of a state of a same portion of the source file system;
adding the one or more snapshots to a queue on the source file system that is associated with the replication relationship, wherein the snapshot is associated with a snapshot retention period that is local to the source file system, wherein the local snapshot retention period is provided by a corresponding snapshot policy that is local to the source file system and a remote replication retention period based on the replication relationship, wherein each snapshot in the queue is ordered based on a time of creation of each snapshot on the source file system, and wherein each snapshot in one or more replication relationship queues is associated with a read only lock until removed from the one or more replication relationship queues; and
determining a snapshot that is in a first position in the queue based on the time of creation, wherein further actions are performed for the determined snapshot, including:
in response to the local snapshot retention period being unexpired and the remote replication retention period being unexpired, copying the snapshot to the target file system;
in response to the local snapshot retention period being expired and the remote replication retention period being unexpired, copying the snapshot to the target file system; and
in response to the local snapshot retention period being expired and the remote replication retention period being expired, discarding the snapshot.

9. The network computer of claim 8, wherein the one or more processors execute instructions that perform actions, further comprising:
generating a replication snapshot on the source file system that is separate from the one or more snapshots;
executing a replication job to copy the replication snapshot from the source file system to the target file system; and
in response to the one or more snapshots being in the queue, performing further actions, including:
pausing the execution of the replication job;
copying the one or more snapshots to the target file system; and
unpausing the execution of the replication job.

10. The network computer of claim 8, wherein copying the snapshot to the target file system, further comprises:
in response to an error condition that interferes with the copying of the snapshot to the target file system, performing further actions, including:
pausing the copying of the snapshot to the target file system; and
resuming the copying of the snapshot to the target file system, wherein one or more portions of the snapshot that are on the target file system are omitted from copying.

11. The network computer of claim 8, wherein the one or more processors execute instructions that perform actions, further comprising:
providing one or more other replication relationships on the source file system, wherein each other replication relationship is associated with a dedicated queue that is separate from the queue; and
associating the one or more snapshot policies with each other replication relationship, wherein one or more different remote retention periods are provided by the one or more other replication relationships.

12. The network computer of claim 8, wherein the one or more processors execute instructions that perform actions, further comprising:
providing one or more source storage systems for the source file system; and
providing one or more target storage systems for the target file system, wherein the one or more source storage systems are associated with higher performance and higher cost than the target storage systems.

13. The network computer of claim 8, wherein the one or more processors execute instructions that perform actions, further comprising, providing one or more blackout periods that are associated with the replication relationship, wherein copying the one or more snapshots in the queue are paused during the one or more blackout periods.

14. The network computer of claim 8, wherein performing the further actions for the determined snapshot, further comprises, in response to the local snapshot retention period being unexpired and the remote replication retention period being expired, removing the snapshot from the queue.

15. A processor readable non-transitory storage media that includes instructions for managing data in a file system over a network, wherein execution of the instructions by one or more processors on one or more network computers performs actions, comprising:
providing a source file system and a target file system that are associated based on a replication relationship, wherein the replication relationship is associated with one or more snapshot policies that are user selectable, and wherein the replication relationship includes three or more different categories of parameters, including snapshot policy parameters, snapshot relationship parameters, and replication parameters, and wherein one or more snapshot policy parameters comprise one or more of a source file system root directory, a snapshot identifier, a blackout window, or a local retention rule, and wherein one or more snapshot relationship parameters comprise one or more of a network address, an identifier of the target file system, a directory in the source file system that is the root directory of the replication relationship, a root directory in the target file system or a blackout period, and wherein one or more replication parameters comprise one or more of a replication period, a replication root directory, or a replication target root directory;
generating one or more snapshots on the source file system based on the one or more snapshot policies, wherein each snapshot is a point-in-time archive of a state of a same portion of the source file system;
adding the one or more snapshots to a queue on the source file system that is associated with the replication relationship, wherein the snapshot is associated with a snapshot retention period that is local to the source file system, wherein the local snapshot retention period is provided by a corresponding snapshot policy that is local to the source file system and a remote replication retention period based on the replication relationship, wherein each snapshot in the queue is ordered based on a time of creation of each snapshot on the source file system, and wherein each snapshot in one or more replication relationship queues is associated with a read only lock until removed from the one or more replication relationship queues; and
determining a snapshot that is in a first position in the queue based on the time of creation, wherein further actions are performed for the determined snapshot, including:
in response to the local snapshot retention period being unexpired and the remote replication retention period being unexpired, copying the snapshot to the target file system;
in response to the local snapshot retention period being expired and the remote replication retention period being unexpired, copying the snapshot to the target file system; and
in response to the local snapshot retention period being expired and the remote replication retention period being expired, discarding the snapshot.

16. The media of claim 15, further comprising:
generating a replication snapshot on the source file system that is separate from the one or more snapshots;
executing a replication job to copy the replication snapshot from the source file system to the target file system; and
in response to the one or more snapshots being in the queue, performing further actions, including:
pausing the execution of the replication job;
copying the one or more snapshots to the target file system; and
unpausing the execution of the replication job.

17. The media of claim 15, wherein copying the snapshot to the target file system, further comprises:
in response to an error condition that interferes with the copying of the snapshot to the target file system, performing further actions, including:
pausing the copying of the snapshot to the target file system; and
resuming the copying of the snapshot to the target file system, wherein one or more portions of the snapshot that are on the target file system are omitted from copying.

18. The media of claim 15, further comprising:
providing one or more other replication relationships on the source file system, wherein each other replication relationship is associated with a dedicated queue that is separate from the queue; and
associating the one or more snapshot policies with each other replication relationship, wherein one or more different remote retention periods are provided by the one or more other replication relationships.

19. The media of claim 15, further comprising:
providing one or more source storage systems for the source file system; and
providing one or more target storage systems for the target file system, wherein the one or more source storage systems are associated with higher performance and higher cost than the target storage systems.

20. The media of claim 15, further comprising, providing one or more blackout periods that are associated with the replication relationship, wherein copying the one or more snapshots in the queue are paused during the one or more blackout periods.

21. The media of claim 15, wherein performing the further actions for the determined snapshot, further comprises, in response to the local snapshot retention period being unexpired and the remote replication retention period being expired, removing the snapshot from the queue.

22. A system for managing data in a file system comprising:
a network computer, comprising:
a memory that stores at least instructions; and
one or more processors that execute instructions that perform actions, including:
providing a source file system and a target file system that are associated based on a replication relationship, wherein the replication relationship is associated with one or more snapshot policies that are user selectable, and wherein the replication relationship includes three or more different categories of parameters, including snapshot policy parameters, snapshot relationship parameters, and replication parameters, and wherein one or more snapshot policy parameters comprise one or more of a source file system root directory, a snapshot identifier, a blackout window, or a local retention rule, and wherein one or more snapshot relationship parameters comprise one or more of a network address, an identifier of the target file system, a directory in the source file system that is the root directory of the replication relationship, a root directory in the target file system or a blackout period, and wherein one or more replication parameters comprise one or more of a replication period, a replication root directory, or a replication target root directory;
generating one or more snapshots on the source file system based on the one or more snapshot policies, wherein each snapshot is a point-in-time archive of a state of a same portion of the source file system;
adding the one or more snapshots to a queue on the source file system that is associated with the replication relationship, wherein the snapshot is associated with a snapshot retention period that is local to the source file system, wherein the local snapshot retention period is provided by a corresponding snapshot policy that is local to the source file system and a remote replication retention period based on the replication relationship, wherein each snapshot in the queue is ordered based on a time of creation of each snapshot on the source file system, and wherein each snapshot in one or more replication relationship queues is associated with a read only lock until removed from the one or more replication relationship queues; and
determining a snapshot that is in a first position in the queue based on the time of creation, wherein further actions are performed for the determined snapshot, including:
in response to the local snapshot retention period being unexpired and the remote replication retention period being unexpired, copying the snapshot to the target file system;
in response to the local snapshot retention period being expired and the remote replication retention period being unexpired, copying the snapshot to the target file system; and
in response to the local snapshot retention period being expired and the remote replication retention period being expired, discarding the snapshot; and
a client computer, comprising:
a memory that stores at least instructions; and
one or more processors that execute instructions that perform actions, including, providing one or more of the one or more snapshot policies or one or more replication relationships.

23. The system of claim 22, wherein the one or more network computer processors execute instructions that perform actions, further comprising:
generating a replication snapshot on the source file system that is separate from the one or more snapshots;
executing a replication job to copy the replication snapshot from the source file system to the target file system; and
in response to the one or more snapshots being in the queue, performing further actions, including:
pausing the execution of the replication job;
copying the one or more snapshots to the target file system; and
unpausing the execution of the replication job.

24. The system of claim 22, wherein copying the snapshot to the target file system, further comprises:
in response to an error condition that interferes with the copying of the snapshot to the target file system, performing further actions, including:
pausing the copying of the snapshot to the target file system; and
resuming the copying of the snapshot to the target file system, wherein one or more portions of the snapshot that are on the target file system are omitted from copying.

25. The system of claim 22, wherein the one or more network computer processors execute instructions that perform actions, further comprising:
providing one or more other replication relationships on the source file system, wherein each other replication relationship is associated with a dedicated queue that is separate from the queue; and
associating the one or more snapshot policies with each other replication relationship, wherein one or more different remote retention periods are provided by the one or more other replication relationships.

26. The system of claim 22, wherein the one or more network computer processors execute instructions that perform actions, further comprising:
providing one or more source storage systems for the source file system; and
providing one or more target storage systems for the target file system, wherein the one or more source storage systems are associated with higher performance and higher cost than the target storage systems.

27. The system of claim 22, wherein the one or more network computer processors execute instructions that perform actions, further comprising, providing one or more blackout periods that are associated with the replication relationship, wherein copying the one or more snapshots in the queue are paused during the one or more blackout periods.

28. The system of claim 22, wherein performing the further actions for the determined snapshot, further comprises, in response to the local snapshot retention period being unexpired and the remote replication retention period being expired, removing the snapshot from the queue.
